(19) United States
(12) Patent Application Publication
(10) Pub. No.: US 2025/0304365 A1
(43) Pub. Date: Oct. 2, 2025

(54) WASTE COLLECTING AND COMPACTING SYSTEM AND METHOD

(71) Applicant: Haull, Inc., Dover, DE (US)

(72) Inventor: Todd A. Perri, Chapel Hill, NC (US)

(21) Appl. No.: 19/237,253

(22) Filed: Jun. 13, 2025

Related U.S. Application Data
(63) Continuation of application No. 18/476,344, filed on Sep. 28, 2023, now Pat. No. 12,340,650.
(60) Provisional application No. 63/480,975, filed on Jan. 22, 2023.
(60) Provisional application No. 63/585,616, filed on Sep. 27, 2023.

(51) Int. Cl. B65F 3/20; B65F 3/26; B65F 3/28

(52) U.S. Cl. CPC B65F 3/203; B65F 3/201; B65F 3/26; B65F 3/28

(57) ABSTRACT

A mobile system used for collecting, compacting, and transporting waste material from a waste generating site. The mobile system includes a waste collection container for holding the waste material therein and a roller compactor for compacting the waste material in the waste collection container to increase a density of the waste material within the waste collection container relative to a density of the waste material in the waste container. The mobile system can also have a transport truck, the waste collection container being attachable to the transport truck.

### CROSS-REFERENCE TO RELATED APPLICATIONS

This application is a continuation of International Patent Application Serial No. PCT/US2023/084227, which was filed on Dec. 15, 2023, which claims priority to U.S. Provisional Patent Application No. 63/433,260, filed on Dec. 16, 2022, U.S. Provisional Patent Application No. 63/433,273, filed on Dec. 16, 2022, and U.S. Provisional Patent Application No. 63/446,965, filed on Feb. 20, 2023, the contents of all of which are incorporated by reference herein in their entirety.

### TECHNICAL FIELD

The subject matter disclosed herein relates to mobile waste handling systems. More particularly, the subject matter disclosed herein relates to mobile systems that are used at least for compacting and transporting bulky waste material away from a waste generating site in an efficient and economical manner.

### BACKGROUND

Roll-off dumpsters have been used for decades by construction companies, distributors, manufacturers, municipalities, and other commercial users, as well as individuals, to discard bulky waste. These dumpsters, also known as bins or containers, typically have five (5) side walls and an open top and vary in size from a few cubic yards to 50 cubic yards or more. The dumpsters are deposited at, and picked up from, designated locations where waste material is expected to be generated and/or collected by a “roll-off” truck, which maneuvers a single dumpster on or off the truck, typically via a cable or hook. Such trucks transport the waste material to an off-site location (e.g., to a dump site or transfer station). Due to the need for transporting waste materials generated during the regular course of business and also the relative abundance and simple construction of such conventional dumpsters, there are currently a number of companies offering services related to the transport, deployment, and removal of such dumpsters throughout the United States.

There are, however, several disadvantages associated with the use of such known conventional dumpsters. Often, the waste material to be disposed of is bulky in nature and is not capable of being readily neatly and efficiently loaded (e.g., in the form in which it is loaded into the dumpster) into such dumpsters. Thus, it is common at present for “full” dumpsters (e.g., dumpsters that are full up to, over, adjacent to, etc. the top of said dumpster) to contain a large amount of voids (e.g., empty space, or air), meaning that the dumpster will contain less waste material (e.g., by mass) than is indicated by the volume of the dumpster and which could be more readily achieved if the waste material were not as bulky. Thus, for example, a dumpster that has a volume of 30 cubic yards may only be able to transport, for example, 3 tons of waste material instead of, for example, 9 tons if the waste material were capable of being packed more efficiently (e.g., having less voids present) within the dumpster. This is particularly disadvantageous because the voids within the dumpster increase the cost of hauling a unit of measure (e.g., a ton) of the waste material; this increased cost is then passed on to consumers. The reason for the increased costs is because the fixed costs associated with retrieving, transporting, and redeploying a dumpster are largely similar, other than waste disposal fees when charged by unit weight or volume, for a company regardless of whether the dumpster is full, empty, inefficiently packed, etc.

Another disadvantage associated with the use of conventional dumpsters is that, in order to accommodate the waste collection and disposal needs of a multitude of different customers, it is almost universally necessary for a company to offer dumpsters of multiple different sizes (e.g., 10, 20, 30, 40, or 50 cubic yards). However, in order to simplify operational logistics, many companies only operate trucks that are capable of transporting the largest dumpster serviced by the company. Thus, even if the waste material were efficiently loaded into the dumpster, the truck itself is carrying less waste material to the collection or disposal site than the truck is otherwise capable of transporting and, therefore, the truck is underutilized, leading to operating costs per dumpster to be higher than could otherwise be possible with a less bulky waste material. The majority of commercial dumpsters have an internal volume of about 30 cubic yards, even though roll-off trucks, like conventional garbage trucks, are known to be capable of carrying larger dumpsters, which would advantageously yield higher overall operational efficiency (e.g., as measured by ton of waste material transported per mile or trip) of the truck. Such 30 cubic yard dumpsters are most commonly used because, at 6 feet high, laborers can reasonably lift and toss waste into the dumpster. Conversely, the use of taller dumpsters are regarded as being prohibitively difficult for laborers to load, even though taller dumpsters with higher volume would maximize the truck's operational efficiency and, therefore, minimize trips to the dump. As will be described further elsewhere herein, the scope of the subject matter disclosed herein will allow for a truck to transport a larger (e.g., 40, 45, or 50 cubic yard) payload to ensure increased operational efficiency.

Still another known disadvantage associated with the use of conventional dumpsters is that, when removing a dumpster from a waste material generation site, the dumpster is often required to be replaced with an empty dumpster in almost exactly the same spot, whether because of municipal codes specifying acceptable dumpster locations; enclosures that are built to limit public access to the dumpsters; the waste material being loaded into the dumpster in an automated, or semi-automated, manner, such as in a factory, for example; or because of the location of the dumpster adjacent to where the waste material is generated. The removal and replacement of conventional dumpsters is both time-consuming and inefficient, generally requiring the truck to carry an empty dumpster to the waste material generating site, deposit the empty dumpster at a first location away from the full dumpster (e.g., so as to not block the truck's path to access the full dumpster, which is to be removed), move (e.g., by pulling and/or sliding) the full dumpster onto the truck, deposit the full dumpster at a second location away from the empty dumpster (e.g., neither at the first location or at a position that would block the truck's path to access the empty dumpster being deposited in the position from which the full dumpster was retrieved), again move (e.g., by pulling and/or sliding) the empty dumpster onto the truck, deposit the empty dumpster in the position from which the full dumpster was retrieved, and move (e.g., by pulling and/or sliding) the full dumpster onto the truck again for transport of the waste material to the specified disposal and/or collection site.

Conventional (i.e., open-top) dumpsters are expensive and it is often necessary for a plurality of such dumpsters to be provided at a waste material generating site. The cost of these dumpsters is often passed on to customers of the company generating the waste material. Additionally, in order to provide a conventional dumpster with a 30 cubic yard volume while having a height that is no more than 6 feet, such conventional dumpsters have lengths of between 20-24 feet, inclusive. However, the use of dumpsters with such a length can be disadvantageous, limiting the locations in which such conventional dumpsters can be deployed. Further, most bulky waste materials do not require a dumpster to have such a length and can be deposited in a dumpster having a much shorter length. As noted elsewhere herein, however, the need at present for known waste transport and compaction systems to physically transport the dumpster renders the use of such smaller dumpsters to be economically disfavored due to lower truck operational efficiency, since only one dumpster can be transported at the same time, regardless of the size/volume of the dumpster itself. However, given the opportunity for deploying smaller dumpsters at more waste collection/generation locations, if this deficiency of such known waste transport and compaction systems were to be addressed.

Conventional waste transport and compaction systems also suffer from an inherent operational inefficiency from the fact that, once emptied (e.g., at a waste aggregation or collection site), the empty dumpsters must be transported back to a waste collection/generation locations (e.g., the same or different location) for redeployment and further waste collection activities. This requirement of transporting each conventional dumpster while empty from the waste aggregation or collection site to a waste collection/generation location is highly inefficient.

Thus, a need exists at present that will address many of the disadvantages associated with the use of known conventional dumpsters used in the storage, transport, and disposal of waste materials that are so commonly used at present. The foregoing disclosure will show how the subject matter disclosed herein addresses (e.g., reduces and/or eliminates entirely) the deficiencies associated with such known dumpsters.

### SUMMARY

According to an example, a mobile system is disclosed herein. This mobile system is for collecting, compacting, and transporting a waste material from a waste generating site. In this example, the mobile system comprises a waste collection container configured to hold the waste material; and a roller compactor configured to compact the waste material in the waste collection container to increase a density of the waste material within the waste collection container relative to a density of the waste material in the waste container.

Optionally, according to any of the example mobile systems disclosed herein, the roller compactor comprises a roller head, which is rotatable about an axis of rotation.

Optionally, according to any of the example mobile systems disclosed herein, the roller compactor comprises a boom arm, which is pivotably and/or rotatably connected to the waste collection container; and a stick arm, which is pivotably connected to the boom arm.

Optionally, according to any of the example mobile systems disclosed herein, the roller compactor comprises an energy storage unit, such as a battery; a motor; and/or a controller configured to receive data transmissions for controlling operation of the roller compactor, optionally, the data transmissions being transmitted in a wireless and/or wired manner.

Optionally, according to any of the example mobile systems disclosed herein, the roller head is configured to be positioned external to the waste collection container while the waste material is transferred into the waste collection container from an external waste container.

Optionally, according to any of the example mobile systems disclosed herein, the roller head is configured to generate a downwardly-oriented compaction force on the waste material within the waste collection container; and wherein the roller head comprises rigidly attached agitators that engage with and break apart the waste material to increase the density of the waste material within the waste collection container.

Optionally, according to any of the example mobile systems disclosed herein, the roller head is powered for rotation to provide propulsion for moving the roller head throughout the waste collection container.

Optionally, according to any of the example mobile systems disclosed herein, the roller head is not powered for rotation, such that the boom arm and the stick arm connected to the roller head are configured to move the roller head throughout the waste collection container, the roller head rotating only due to friction with the waste material being compacted.

Optionally, according to any of the example mobile systems disclosed herein, the roller head is narrower than a width of the waste collection container.

Optionally, according to any of the example mobile systems disclosed herein, for moving the roller head throughout the waste collection container, the boom arm is configured to extend, retract, pivot up, pivot down, swivel left, and/or swivel right; and the stick arm is configured to extend, retract, pivot up, and/or pivot down.

Optionally, according to any of the example mobile systems disclosed herein, the roller compactor is configured to compact and shred the waste material within the waste collection container.

Optionally, according to any of the example mobile systems disclosed herein, the waste compactor is mounted to the waste collection container in such a way that the roller head is movable throughout the waste collection container, including in forward, rear, up, and down directions.

Optionally, according to any of the example mobile systems disclosed herein, such example mobile systems can comprise a door or gate in a rear wall of the waste collection container, wherein the roller compactor is mounted to a top edge of the waste collection container, above the door or gate.

Optionally, according to any of the example mobile systems disclosed herein, the roller compactor is mounted to a top edge of the waste collection container, above the door or gate; or the roller compactor is mounted to the top edge of the waste collection container on a front side thereof, opposite the door or gate.

Optionally, according to any of the example mobile systems disclosed herein, such example mobile systems can comprise a transport truck configured to have the waste collection container attached thereto.

Optionally, according to any of the example mobile systems disclosed herein, the transport truck is configured as a dump truck, the waste collection container being pivotably attached to the transport truck; or the transport truck is configured as a roll-off truck, the waste collection container being configured to slide or roll on and off of the transport truck.

Optionally, according to any of the example mobile systems disclosed herein, the waste compactor is mounted to the transport truck in such a way that the roller head is movable throughout the waste collection container, including in forward, rear, up, and down directions.

According to another example, a method for collecting, compacting, and transporting a waste material from a waste container at a waste generating site is disclosed herein. In this example, the method comprises providing a waste collection container; receiving the waste material from the waste container within the waste collection container; and compacting, via a roller compactor, the waste material in the waste collection container to increase a density of the waste material within the waste collection container relative to a density of the waste material in the waste container.

Optionally, according to any of the example methods disclosed herein, the roller compactor comprises a roller head, which is rotatable about an axis of rotation.

Optionally, according to any of the example methods disclosed herein, the roller compactor comprises a boom arm, which is pivotably and/or rotatably connected to the waste collection container; and a stick arm, which is pivotably and/or rotatably connected to the boom arm.

Optionally, according to any of the example methods disclosed herein, the roller compactor comprises an energy storage unit, such as a battery; a motor;

and/or a controller that receives data transmissions for controlling operation of the roller compactor, optionally, the data transmissions being transmitted in a wireless and/or wired manner.

Optionally, according to any of the example methods disclosed herein, the method comprises positioning the roller head external to the waste collection container while the waste material is being received in the waste collection container.

Optionally, according to any of the example methods disclosed herein, the method comprises generating, with the roller head, a downwardly-oriented compaction force on the waste material within the waste collection container, wherein the roller head comprises rigidly attached agitators that engage with and break apart the waste material to increase the density of the waste material within the waste collection container.

Optionally, according to any of the example methods disclosed herein, the roller head is powered for rotation to provide propulsion for moving the roller head throughout the waste collection container.

Optionally, according to any of the example methods disclosed herein, the roller head is not powered for rotation, such that the boom arm and the stick arm connected to the roller head move the roller head throughout the waste collection container, the roller head rotating only due to friction with the waste material being compacted.

Optionally, according to any of the example methods disclosed herein, the roller head is narrower than a width of the waste collection container.

Optionally, according to any of the example methods disclosed herein, for moving the roller head throughout the waste collection container, the boom arm is movable in extension, retraction, pivoting up, pivoting down, swiveling left, and/or swiveling right direction; and/or the stick arm is movable in extension, retraction, pivoting up, and/or pivoting down.

Optionally, according to any of the example methods disclosed herein, the method comprises using the roller compactor to compact and shred the waste material within the waste collection container.

Optionally, according to any of the example methods disclosed herein, the method comprises mounting the waste compactor to the waste collection container in such a way that the roller head is movable throughout the waste collection container, including in forward, rear, up, and down directions.

Optionally, according to any of the example methods disclosed herein, the method comprises pivotably attaching a door or gate in a rear wall of the waste collection container, wherein the roller compactor is mounted to a top edge of the waste collection container, above the door or gate.

Optionally, according to any of the example methods disclosed herein, the roller compactor is mounted to a top edge of the waste collection container, above the door or gate; or the roller compactor is mounted to the top edge of the waste collection container on a front side thereof, opposite the door or gate.

Optionally, according to any of the example methods disclosed herein, the method comprises attaching the waste collection container to a transport truck.

Optionally, according to any of the example methods disclosed herein, the waste collection container is pivotably attached to the transport truck, in a manner of a dump truck; or the waste collection container can slide or roll on and off of the transport truck, in a manner of a roll-off truck.

Optionally, according to any of the example methods disclosed herein, the waste compactor is mounted to the transport truck in such a way that the roller head is movable throughout the waste collection container, including in forward, rear, up, and down directions.

### BRIEF DESCRIPTION OF THE DRAWINGS

FIG. 1 is a schematic side view of an example embodiment of a mobile system in the form of a stand-alone waste collection container comprising a roller compactor.

FIG. 2 is a schematic side view of another example embodiment of mobile system in the form of a truck with another example embodiment of a waste collection container pivotably attached thereto.

FIG. 3 is a schematic side view of another example embodiment of a mobile system in the form of a stand-alone waste collection container comprising a roller compactor.

FIG. 4 is a schematic side view of another example embodiment of a mobile system in the form of a truck with another example embodiment of a waste collection container pivotably attached thereto.

FIG. 5 is a schematic side view of an example embodiment of a conventional roll-off style truck with the mobile system of FIG. 3 attached thereto.

FIG. 6 is a side schematic view of another example embodiment of a mobile system in the form of a waste transport and compaction system having at least one waste compactor, aspects of which are shown in FIGS. 7 and 8, FIG. 6 specifically showing examples of movement of a waste container when transferring waste material from the waste container into the mobile system.

FIG. 7 is a front schematic view of an example embodiment of a waste compactor of the type used in the mobile system shown in FIG. 6.

FIG. 8 is a side schematic view of the example embodiment of the waste compactor within the waste container, as shown in FIG. 7.

FIG. 9 is a side schematic view of another example embodiment of a mobile system.

FIG. 10 is a side schematic view of another example embodiment of a mobile system.

FIG. 11 is a side schematic view of the mobile system shown in FIG. 10, further showing the movement of the dumpster as the waste material is transferred onto the transport truck.

FIG. 12 is a is a side schematic view of another example embodiment of a mobile system, similar to that which is shown in FIG. 10, but configured to lift a waste container positioned at the rear of the truck.

FIG. 13 is a side schematic view of a mobile system in the form of a transport truck, with waste collection container attached to the transport truck and a roller compactor attached to the transport truck, between a passenger cab of the transport truck and the waste collection container.

### DETAILED DESCRIPTION

Various example embodiments of mobile systems are disclosed herein for the efficient transport and disposal of waste material. The terms “mobile system” and “waste transport/compaction system” can be used interchangeably herein. The example mobile systems disclosed herein are advantageously used for compacting and/or hauling bulky waste materials, meaning waste materials that naturally have a large amount (e.g., as a percentage) of air, or voids, of a total volumetric region occupied by the waste material in an uncompacted state. Thus, these bulky waste materials are materials that are capable of undergoing a high level of compaction. Non-limiting examples of such bulky waste materials include pallets (e.g., wooden pallets), cardboard, crates, boxes, furniture, and the like.

The mobile systems disclosed herein are more efficient that currently known systems and methods for transporting and disposing of waste materials, as the disclosed mobile systems enable a larger mass of the waste material to fit into any desired waste collection container, which can be of any suitable size. Thus, by using the disclosed mobile systems, it is possible to load, transport, and dispose of a mass of waste material that is greater than what is possible using known systems and devices, allowing a single truck to transport a mass of waste material that would require two or more trucks to transport using conventionally known technology.

A further advantage provided with the mobile systems disclosed herein is that waste material may be collected from multiple different locations without requiring the transport of the waste containers from each of these different locations. Thus, the mobile systems disclosed herein can receive waste material into the waste collection container at a first location, compact the waste material, move to a second location, receive additional waste material into the waste collection container at the second location, compact the waste material, and proceed to another location, repeating the steps of receiving waste material into the waste collection container, compacting the waste material within the waste collection container, and moving to another location until the waste collection container is full and cannot be loaded with any more waste material without first being emptied (e.g., at a disposal or collection site). The waste materials from different locations can be the same or different from each other.

Thus, the mobile systems disclosed herein are operable at higher efficiencies compared to known systems and allow for reduced operating and capital costs because the mobile systems disclosed herein can compact the waste material such that the density of the waste material within the waste collection container is greater than the density of the waste material within the container at the waste generating size from which the waste material was received within the waste collection container. As an illustrative example for the increased efficiency provided by the disclosed mobile systems, the waste collection container can have a volume of 45 cubic yards. The waste compactor of the mobile system can be used to compact the waste material (e.g., pallets) received within the waste collection container from a 30 cubic yard open-top dumpster by 50% (e.g., such that the compacted waste material in the waste collection container occupies 50% of the volume of the uncompacted waste material when in the waste container). Thus, such the example mobile systems disclosed herein are capable of transporting a mass of waste material equivalent to what would require three (3) trucks and open-top containers known from the prior art.

A further advantage is provided by using the mobile systems disclosed herein, in which compaction and removal of the waste material is performed in a single trip, rather than requiring multiple trips by multiple vehicles as is currently required using known technology. A further advantage provided is that mobile systems disclosed herein are able to provide greater compaction than currently known compactors (i.e., trucks with a roller compactor attached thereto, with no waste collection container attached to the trucks). The reason for this is that it is not economical for such currently known compactors to revisit the waste material generating site to compact any additional waste material added to the dumpster before the waste material is removed (e.g., by being transported on a truck) from the waste material generating site, thereby leaving at least some portion of the waste material uncompacted, which causes the dumpster to not be filled with as great a mass of the waste material as would be possible if the waste material were compacted immediately before removal from the waste material generating site.

It further is noted that, even if a conventional compactor were to repeatedly be sent to the same waste material generating site to compact waste material within a dumpster, the uncompacted portion of the waste material within the dumpster would diminish. By way of example, assuming the dumpster were full and a conventional compactor were used to compact the volume by 50%, then the 50% of the dumpster volume available were filled again with uncompacted waste material, and a conventional dumpster were used again to compact the uncompacted waste material by 50% volume, leaving 25% of the dumpster volume empty. This would continue until the dumpster is substantially full, but the intervals between when the compactor would need to be used would be increasingly shortened after each compaction, which is not commercially feasible. Due to the diminishing efficacy of performing multiple compactions, using known systems and methods results in even a “full” dumpster being almost certain to contain a significant portion (e.g., greater than 10%, greater than 25%, or greater than 50%) by volume of the contents thereof that are uncompacted, since there are no known systems that both compact and remove waste material from a waste material generating site in a single trip, much less transfer compacted waste material into a waste collection container on the truck so that it is possible for the mobile systems disclosed herein to contain entirely (e.g., 100% by volume) compacted waste material. Rather, the presently disclosed mobile systems and methods load and compact waste material during the same visit to a waste material generating site, enabling all of the waste material that is removed and transported from the waste material generating site to be compacted. Additionally, since the presently disclosed mobile systems and methods are capable of loading and compacting the waste material in increments (e.g., by compacting the waste material when only a portion of a waste container's waste material has been received in the waste collection container), the presently disclosed mobile systems and methods provide improved levels of compaction than conventional standalone mobile compactors, which compact containers that are full (e.g., at least 95% full by volume) or substantially full (e.g., at least 90% or at least 80% full by volume), such that a significant amount (e.g., up to 50% by volume) of the waste material that is removed by the conventional waste material removal and transport systems is not compacted, since repeat trips by a conventional compactor offer diminishing returns, both practically and economically, due to the fact that each subsequent trip would only compact an ever-decreasing portion of the container, unlike in the presently disclosed mobile systems and methods, in which the waste material is loaded into the waste collection container and compacted in increments (e.g., by only loading a first portion of waste material from a waste container into the waste collection container, compacting this first portion of the waste material, loading a second portion of waste material from the waste container into the waste collection container, compacting this second portion of the waste material, and repeating until either the waste collection container is full or substantially full with compacted waste material).

In some embodiments, the presently disclosed mobile systems and methods are advantageous in that conventionally used large open-top dumpsters can be replaced at waste material generating sites with less expensive containers, smaller containers, or even with no containers for some types of waste material. Conventional open-top dumpsters are expensive, in part, because they must be rigid and durable to withstand years of being pulled on and off the roll-off trucks, as well as being safe while transporting waste material therein. While the presently disclosed mobile systems and methods are configured to transfer waste material from such conventional open-top dumpsters into the waste collection containers disclosed herein, the use of such conventional open-top dumpsters is not required and, in fact, the waste collection containers disclosed herein are configured to receive waste material from any suitable source (e.g., including a pile of waste material on the ground). This ability to utilize different or no waste containers is advantageous, in that it provides increased operational flexibility and cost-savings for customers, who may opt to use an open area, their own waste containers, smaller waste containers, less rigid waste containers (e.g., flexible bags made of a suitably durable material), or no waste containers. For example, the waste collection containers disclosed herein can be used in place of a conventional roll-off style dumpster for the collection and containment of waste material and can, in fact, be operated to compact the waste material periodically or upon receipt of a command to do so, such as when a level of waste material within the waste collection container has been detected as being above a top surface of the waste collection container. In some situations, the mobile systems disclosed herein can be provided with waste collection containers that have a smaller volume than would be necessary for a conventional dumpster, since such mobile systems can compact the waste material as and/or after the waste material is received within the waste collection container, thereby negating the need for use of a large, conventional open-top dumpster to contain the uncompacted volume of the waste material. The use of smaller waste collection containers in the presently disclosed mobile waste systems than is required for known systems that use a conventional dumpster is more economical.

A further benefit provided by the presently disclosed mobile systems and methods is the ability to receive, when mounted onto the back of a transport truck, for example, waste material from multiple waste containers at a waste material generating site, unlike conventional waste material removal and transport systems, in which only a single waste container (e.g., conventional dumpster) can be transported at a time on one transport truck, regardless of the size or volume of the waste container. For example, the presently disclosed mobile systems and methods are more economical and versatile than known systems because the presently disclosed mobile systems can receive waste material from multiple waste containers at a waste material generating site, whereas conventional systems using conventional roll-off dumpsters and conventional roll-off transport trucks can only transport one waste container at a time.

The mobile systems and methods disclosed herein are more economical and versatile than conventionally known shredders, grinders, and/or chippers for mobile removal of bulky waste. The presently disclosed mobile systems and methods can compact virtually any type of waste material, whereas conventional shredders, grinders, and chippers are either limited to process only specific types of waste materials in order to prevent jamming of the machine, or are so massive and expensive as to be impractical for use in a mobile application. Additionally, the presently disclosed mobile systems and methods both compact and also shred the waste material, unlike some conventional shredders that output a waste product that is fluffy and unsuitable for compaction.

While example embodiments of mobile systems and methods are shown herein, the mobile systems and methods disclosed herein can be incorporated into any suitable configuration(s). In some embodiments, the vehicle of the example mobile systems disclosed herein is a so-called dump truck, which has a waste collection container that is attached to the frame, or chassis, of the truck and is pivotable about an axis of rotation, typically defined at the rear edge of the container (e.g., relative to the edge nearest the cabin of the dump truck), such that compacted waste material can be removed from the waste collection container by pivoting the waste collection container about the axis of rotation and opening a door or gate formed as all or a portion of the rear wall of the waste collection container, such that the compacted waste material slides (e.g., due to gravity) out of the waste collection container. In some such embodiments, the waste compactor is mounted to the waste collection container itself. In such embodiments, the waste compactor can advantageously be powered via permanent connections to the power take-off (PTO) and electrical system of the dump truck.

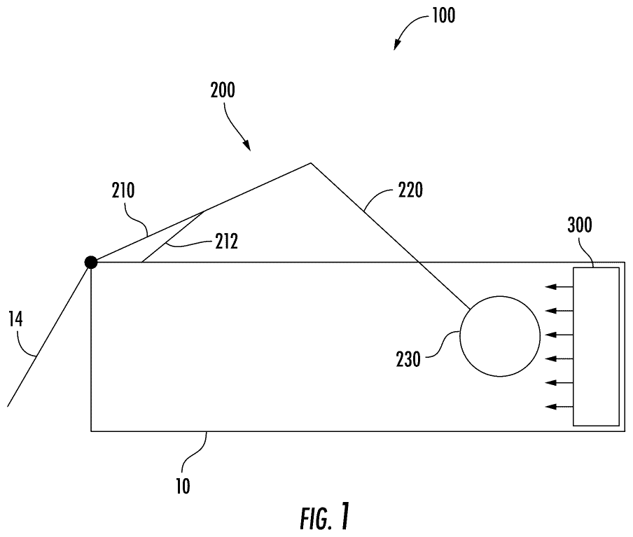

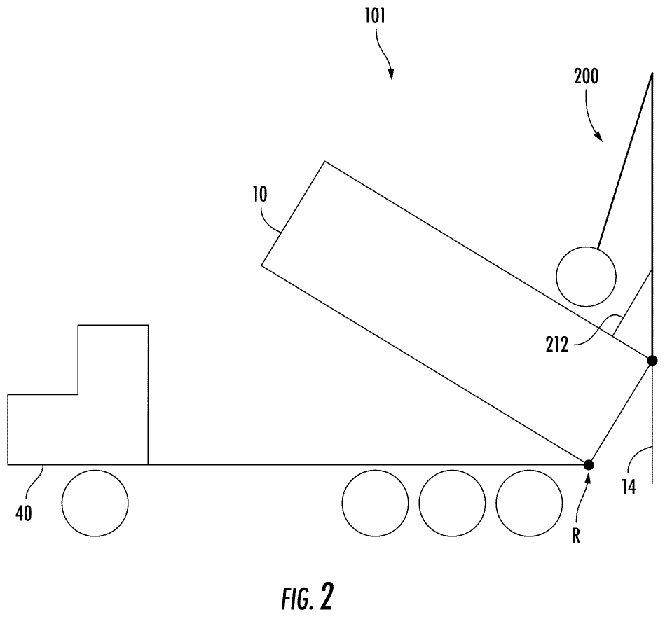

FIG. 1 shows a first example embodiment of such a mobile system, generally designated 100, according to the subject matter disclosed herein. The mobile system 100 comprises a waste collection container 10 (e.g., an open-top dumpster), a roller compactor, generally designated 200, and, optionally, a horizontal compactor 300. The waste collection container 10 comprises a door 14 that is pivotably attached at a rear end, or surface, of the waste collection container 10, preferably at a top edge of the waste collection container 10. In this example, the roller compactor 200 is attached to the same end of the waste collection container 10 as the door 14. The horizontal compactor 300 is provided in the end of the waste collection container 10 that is opposite the rear end, where the door 10 is pivotably attached. The mobile system 100 shown in FIG. 1 is configured to be loaded and transported on a suitable transport truck, which can include a conventional roll-off truck. In some embodiments, the waste collection container 10 can be pivotably attached to such a transport truck, substantially identically to the illustration of the mobile system 101 shown in FIG. 2. The terms “truck” and “vehicle” can be used interchangeably and generally refer to a mobile conveyance capable of operating in the manner described herein. Thus, in some embodiments, the mobile system 100 of FIG. 1 is capable of operating as a direct replacement for a conventional dumpster. The mobile system 100 of FIG. 1 is removably attached to the transport truck during transport to and/or from a waste disposal and/or collection site.

Pivoting of the door 14 relative to the waste collection container 10 can be actively or passively driven. In an actively driven embodiment, the pivoting movement of the door 14 is controlled by, for example and without limitation, an actuator, arm, linkage, etc. that moves the door 14 relative to the waste collection container 10. In a passively driven embodiment, the door 14 pivots freely relative to the waste collection container 10 and generally pivots into a position such that the door 14 is coaxial with the gravity vector. A hook, latch, release, etc. may be provided in either embodiment for securing the door 14 during, for example, transport of the waste collection container 10 to prevent unwanted opening of the door 14. The provision of an actively driven door 14 is particularly advantageously used in embodiments in which waste collection container 10 is intended for use on a truck that is not a dump truck. The reason for this is because the horizontal compactor 300 or another device would, in such a configuration, not only have to exert a force sufficient to move the waste material towards the door 14, but would also have to exert a force of sufficient magnitude to also cause the door 14 to pivot into the open position, allowing for the waste material to be expelled from the waste collection container 10.

In some embodiments of the mobile system 100, the bottom surface or floor (e.g., the surface on which the waste material is supported) of the waste collection container 10 is a solid, or substantially solid, structure (e.g., a plate, sheet, etc.). In some embodiments of the mobile system 100, the bottom surface or floor of the waste collection container 10 is a so-called “walking floor” comprising a conveyor-like structure that is used to empty the waste material from the waste collection container 10.

In the example mobile system 100, the roller compactor 200 comprises a boom arm 210, a stick arm 220, and a roller head assembly 230. The boom arm 210 is attached to the waste collection container 10 at a position that allows for the boom arm 210 to pivot in a vertically-extending plane and swivel in a horizontally-extending plane. The pivoting movement of the boom arm 210 is controlled by the actuator 212. The stick arm 220 is pivotably attached to the boom arm 210 at a distal end of the boom arm 210, opposite the proximal end of the boom arm 210 where the boom arm 210 is attached to the waste collection container 10. The roller compactor 200 comprises a second actuator extending between the boom arm 210 and the stick arm 220 for controlling, by an extension or retraction of the second actuator, a pivoting movement of the stick arm 220 about the distal end of the boom arm 210. The roller head assembly 230 is attached, at a distal end of the stick arm 220, to the stick arm 220. The roller head assembly 230 has a rigid frame, by which the roller head is attached to the stick arm 220. The rigid frame of the roller head assembly 230 is mobile relative to the stick arm 220. For example, the rigid frame may pivot (e.g., rotate in the plane shown in FIG. 1) about the distal end of the stick arm 220, swivel (e.g., rotate in the plane defined by the longitudinal axis of the stick arm 220 and the direction perpendicular to the plane shown in FIG. 1) about the distal end of the stick arm 220, and/or rotate with respect to the longitudinal axis of the stick arm 220. In some embodiments, the roller compactor 200 can have a pivotable, swivelable, and/or rotatable wrist structure, by which the roller head assembly 230 can be attached to the stick arm 220. In some embodiments, the boom arm 210 and/or the stick arm 220 are telescoping arms, with an adjustable length.

The roller compactor 200 is not in any way limited to having only a boom arm 210 and a stick arm 220. Instead, the roller compactor 200 can have any suitable construction, quantity, and type of arms, arm segments, sections, and the like. A nonlimiting example of such arms or arm segments includes one or more telescoping arms or telescoping arm segments. These arms, arm segments, and sections can move in relation to each other in any suitable manner based on the design of the roller compactor 200.

The roller head assembly 230 comprises, in some embodiments, a multi-ton roller head that is rotatably attached to the rigid frame. The roller head has agitators (e.g., spiked teeth) attached to the outer circumferential surface of the roller head. These agitators are shaped and attached to the outer circumferential wall of the roller head to compact and shred virtually any type of bulky waste material into smaller pieces that are more readily compressible with smaller total void area (e.g., having a greater density) within the waste collection container 10. The roller head of the roller head assembly 230 can be either self-powered or unpowered.

In a self-powered embodiment, the roller head assembly 230 can be operably attached to a power source (e.g., hydraulic, pneumatic, or electric) of the waste collection container 10. The power source can be used to move not only the roller head of the roller head assembly 230, but also to move the boom arm 210 relative to the waste collection container 10, to move the stick arm 220 relative to the boom arm 210, and to move the rigid frame of the roller head assembly 230 relative to the stick arm 220. In some self-powered embodiments, the roller head assembly 230 includes an energy storage unit, such as a battery, a motor, and/or a controller configured to receive wireless data transmissions for controlling operation of the roller head.

In the unpowered embodiment, the roller head is not rotatably driven relative to the rigid frame of the roller head assembly 230. Instead, the weight of the roller head is used to exert a compacting force on the waste material, the compacting force acting, for example, in a generally downward direction and the roller head assembly 230 is moved forward-reverse, left-right, and/or up-down by the boom arm 210 and the stick arm 220 of the roller compactor 200, such that the roller head spins as a result of the frictional contact of the roller head 230 with the waste material while the roller head assembly 230 is being moved within the waste collection container 10 by the boom arm 210 and stick arm 220.

In some embodiments, the roller compactor 200 is configured such that the roller head assembly 230 can be positioned external to the waste collection container 10 during loading of the waste material into the waste collection container 10 and during removal of the waste material from the waste collection container 10. An example schematic illustration showing the roller head assembly 230 external from the waste collection container is shown in FIG. 2. Optionally, the waste collection container 10 can be provided with a storage structure configured to hold the roller head assembly 230 in a designated location when not in use, so that the roller head assembly 230 does not interfere with the loading/unloading of the waste material into/from the waste collection container 10. In some such embodiments, the storage structure comprises an electrical charger configured to transfer electrical power to the energy storage unit of the roller head assembly 230 (e.g., only while the roller head assembly 230 is positioned in, such as in via direct contact with, electrical contacts provided within the storage structure).

In the example embodiment of the mobile system 100 disclosed herein, the waste collection container 10 is configured as an open-top container, but is not necessarily limited to such configurations; as such, the waste collection container 10 can be any suitable type of container. In some embodiments, the waste collection container 10 can be a structure that is not analogous to a conventional container, at least as such term may be used to conventionally describe a dumpster.

FIG. 2 shows another example embodiment of a mobile system, generally designated 101, in which a waste collection container 10 is pivotably attached to a vehicle, such as transport truck 40. The waste collection container 10 shown in FIG. 2 is substantially similar to the waste collection container shown in FIG. 1. Thus, the mobile system 101 comprises a transport truck 40, a waste collection container 10, and a roller compactor, generally designated 200. The mobile system 101 does not, unlike in mobile system 100, include a horizontal compactor (300, FIG. 1), since the waste material in the waste collection container 10 of FIG. 2 can be unloaded using the force of gravity, such as by rotating the waste collection container 10 from a horizontal position into the inclined position shown in FIG. 2. In the mobile system 101, the waste collection container 10 comprises a door 14 that is pivotably attached at a rear end, or surface, of the waste collection container 10, preferably at a top edge of the waste collection container 10. In this example, the roller compactor 200 is attached to the same end of the waste collection container 10 as the door 14.

The transport truck 40 is configured as a dump truck, in which the waste collection container 10 is attached to the transport truck 40 in a manner that allows the waste collection container 10 to pivot about an axis of rotation R. In the mobile system 101, the waste collection container 10 can be permanently or removably attached to the transport truck 40 during transport of the waste material within the waste collection container 10 to and/or from a waste disposal and/or collection site. Since the mobile system 101 does not have a horizontal compactor, the mobile system 101 relies on gravity-driven unloading of the waste material from the waste collection container 10 upon the waste collection container 10 being pivoted about the axis of rotation R into an inclined position (e.g., in the clockwise direction in the view shown in FIG. 2). While the transport truck 40 is disclosed in this example embodiment as being configured as a dump truck, in some other embodiments, the transport truck 40 may be configured as flat-bed trucks (e.g., trucks that cannot pivot the waste collection container); in such embodiments, a waste collection container 10 having a horizontal compactor (e.g., 300, see FIG. 1), or a similar device or system (e.g., a walking floor) is advantageously utilized for unloading the waste material from the waste collection container 10. Thus, in some embodiments, the waste collection container 10 of the mobile system 101 may have, for example, a horizontal compactor and/or a walking floor for unloading the waste material from the waste collection container 10 thereof. In some embodiments, the roller compactor 200 can be used to expel the waste material from the waste collection container 10 by rotating the roller head of the roller head assembly within the waste collection container 10 against the waste material contained therein, the direction of rotation being in the direction that drives the waste material being contacted by the roller head towards the exit (e.g., door 14) of the waste collection container 10.

Pivoting of the door 14 relative to the waste collection container 10 can be actively or passively driven. In an actively driven embodiment, the pivoting movement of the door 14 is controlled by, for example and without limitation, an actuator, arm, linkage, etc. that moves the door 14 relative to the waste collection container 10. In a passively driven embodiment, the door 14 pivots freely relative to the waste collection container 10 and generally pivots into a position such that the door 14 is coaxial with the gravity vector. A hook, latch, release, etc. may be provided in either embodiment for securing the door 14 during, for example, transport of the waste collection container 10 to prevent unwanted opening of the door 14. The provision of an actively driven door 14 is particularly advantageously used in embodiments in which waste collection container 10 is intended for use on a truck that is not a dump truck. The reason for this is because a horizontal compactor or other device would have to exert a force of sufficient magnitude to also cause the door 14 to pivot into the open position, allowing for the waste material to be expelled from the waste collection container 10.

In some embodiments of the mobile system 101, the bottom surface or floor (e.g., the surface on which the waste material is supported) of the waste collection container 10 is a solid, or substantially solid, structure (e.g., a plate, sheet, etc.). In some embodiments of the mobile system 101, the bottom surface or floor of the waste collection container 10 is a so-called “walking floor” comprising a conveyor-like structure that is used to empty the waste material from the waste collection container 10.

In the example mobile system 101, the roller compactor 200 comprises a boom arm 210, a stick arm 220, and a roller head assembly 230. The boom arm 210 is attached to the waste collection container 10 at a position that allows for the boom arm 210 to pivot in a vertically-extending plane and swivel in a horizontally-extending plane. The pivoting movement of the boom arm 210 is controlled by the actuator 212. The stick arm 220 is pivotably attached to the boom arm 210 at a distal end of the boom arm 210, opposite the proximal end of the boom arm 210 where the boom arm 210 is attached to the waste collection container 10. The roller compactor 200 comprises a second actuator extending between the boom arm 210 and the stick arm 220 for controlling, by an extension or retraction of the second actuator, a pivoting movement of the stick arm 220 about the distal end of the boom arm 210. The roller head assembly 230 is attached, at a distal end of the stick arm 220, to the stick arm 220. The roller head assembly 230 has a rigid frame, by which the roller head is attached to the stick arm 220. The rigid frame of the roller head assembly 230 is mobile relative to the stick arm 220. For example, the rigid frame may pivot (e.g., rotate in the plane shown in FIG. 2) about the distal end of the stick arm 220, swivel (e.g., rotate in the plane defined by the longitudinal axis of the stick arm 220 and the direction perpendicular to the plane shown in FIG. 2) about the distal end of the stick arm 220, and/or rotate with respect to the longitudinal axis of the stick arm 220. In some embodiments, the roller compactor 200 can have a pivotable, swivelable, and/or rotatable wrist structure, by which the roller head assembly 230 can be attached to the stick arm 220. In some embodiments, the boom arm 210 and/or the stick arm 220 are telescoping arms, with an adjustable length.

The roller compactor 200 is not in any way limited to having only a boom arm 210 and a stick arm 220. Instead, the roller compactor 200 can have any suitable construction, quantity, and type of arms, arm segments, sections, and the like. A nonlimiting example of such arms or arm segments includes one or more telescoping arms or telescoping arm segments. These arms, arm segments, and sections can move in relation to each other in any suitable manner based on the design of the roller compactor 200.

The roller head assembly 230 comprises, in some embodiments, a multi-ton roller head that is rotatably attached to the rigid frame. The roller head has agitators (e.g., spiked teeth) attached to the outer circumferential surface of the roller head. These agitators are shaped and attached to the outer circumferential wall of the roller head to compact and shred virtually any type of bulky waste material into smaller pieces that are more readily compressible with smaller total void area (e.g., having a greater density) within the waste collection container 10. The roller head of the roller head assembly 230 can be either self-powered or unpowered.

In a self-powered embodiment, the roller head assembly 230 can be operably attached to a power source (e.g., hydraulic, pneumatic, or electric) of the waste collection container 10. The power source can be used to move not only the roller head of the roller head assembly 230, but also to move the boom arm 210 relative to the waste collection container 10, to move the stick arm 220 relative to the boom arm 210, and to move the rigid frame of the roller head assembly 230 relative to the stick arm 220. In some self-powered embodiments, the roller head assembly 230 includes an energy storage unit, such as a battery, a motor, and/or a controller configured to receive wireless data transmissions for controlling operation of the roller head.

In the unpowered embodiment, the roller head is not rotatably driven relative to the rigid frame of the roller head assembly 230. Instead, the weight of the roller head is used to exert a compacting force on the waste material, the compacting force acting, for example, in a generally downward direction and the roller head assembly 230 is moved forward-reverse, left-right, and/or up-down by the boom arm 210 and the stick arm 220 of the roller compactor 200, such that the roller head spins as a result of the frictional contact of the roller head 230 with the waste material while the roller head assembly 230 is being moved within the waste collection container 10 by the boom arm 210 and stick arm 220.

In some embodiments, the roller compactor 200 is configured such that the roller head assembly 230 can be positioned external to the waste collection container 10 during loading of the waste material into the waste collection container 10 and during removal of the waste material from the waste collection container 10. The roller head assembly 230 is shown external from the waste collection container 10 in FIG. 2. Optionally, the waste collection container 10 can be provided with a storage structure configured to hold the roller head assembly 230 in a designated location when not in use, so that the roller head assembly 230 does not interfere with the loading/unloading of the waste material into/from the waste collection container 10. In some such embodiments, the storage structure comprises an electrical charger configured to transfer electrical power to the energy storage unit of the roller head assembly 230 (e.g., only while the roller head assembly 230 is positioned in, such as in via direct contact with, electrical contacts provided within the storage structure).

In the example embodiment of the mobile system 101 disclosed herein, the waste collection container 10 is configured as an open-top container, but is not necessarily limited to such configurations; as such, the waste collection container 10 can be any suitable type of container. In some embodiments, the waste collection container 10 can be a structure that is not analogous to a conventional container, at least as such term may be used to conventionally describe a dumpster.

In the example embodiment of the mobile system 101, the transport truck 40 is a lift-back truck, by which the waste collection container 10 is configured to be pivoted about an axis of rotation R to facilitate dumping waste material out of the waste collection container 10. The waste collection container 10 is advantageously only temporarily attached to the transport truck 40 (e.g., in a manner so as to be readily and repeatedly moved onto and off of the transport truck 40) in the mobile system 101.

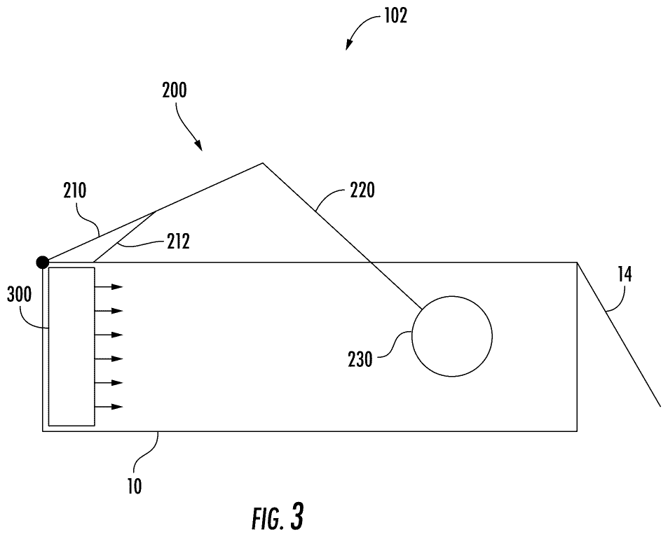

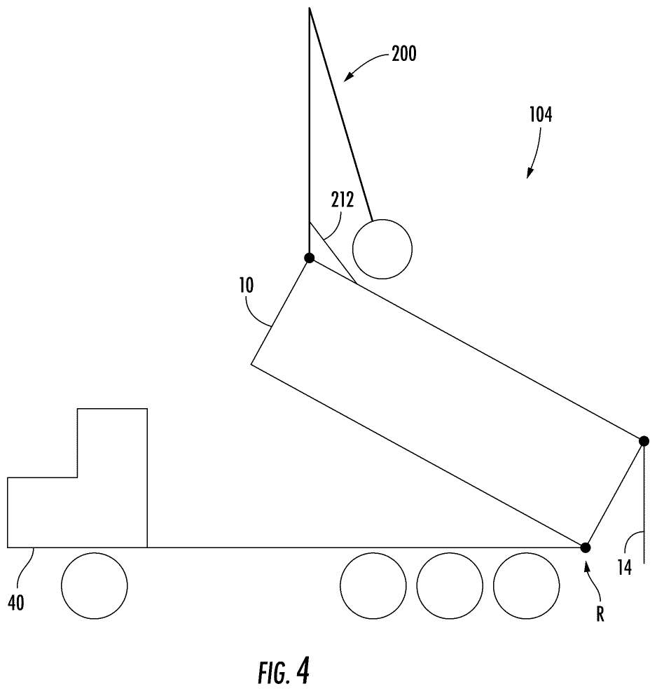

FIG. 3 shows another example embodiment of such a mobile system, generally designated 102, according to the subject matter disclosed herein. The mobile system 102 comprises a waste collection container 10 (e.g., an open-top dumpster), a roller compactor, generally designated 200, and, optionally, a horizontal compactor 300. The waste collection container 10 comprises a door 14 that is pivotably attached at a rear end, or surface, of the waste collection container 10, preferably at a top edge of the waste collection container 10. In this example, the roller compactor 200 is attached to a front end, or surface, of the waste collection container 10 from the rear end where the door 14 is attached to the waste collection container 10. The horizontal compactor 300 is also provided in the front end of the waste collection container 10, the same end where the roller compactor 200 is attached to the waste collection container 10 attached. The mobile system 102 is configured to be loaded and transported on a suitable transport truck, which can include a conventional roll-off truck. In some embodiments, the waste collection container can be pivotably attached to such a transport truck, substantially identically to the illustration shown in FIG. 4. The terms “truck” and “vehicle” can be used interchangeably and generally refer to a mobile conveyance capable of operating in the manner described herein. Thus, in some embodiments, the mobile system 102 of FIG. 3 is capable of operating as a direct replacement for a conventional dumpster. The mobile system 102 is removably attached to the transport truck during transport to and/or from a waste disposal and/or collection site.

Pivoting of the door 14 relative to the waste collection container 10 can be actively or passively driven. In an actively driven embodiment, the pivoting movement of the door 14 is controlled by, for example and without limitation, an actuator, arm, linkage, etc. that moves the door 14 relative to the waste collection container 10. In a passively driven embodiment, the door 14 pivots freely relative to the waste collection container 10 and generally pivots into a position such that the door 14 is coaxial with the gravity vector. A hook, latch, release, etc. may be provided in either embodiment for securing the door 14 during, for example, transport of the waste collection container 10 to prevent unwanted opening of the door 14. The provision of an actively driven door 14 is particularly advantageously used in embodiments in which waste collection container 10 is intended for use on a truck that is not a dump truck. The reason for this is because the horizontal compactor 300 or another device would, in such a configuration, not only have to exert a force sufficient to move the waste material towards the door 14, but would also have to exert a force of sufficient magnitude to also cause the door 14 to pivot into the open position, allowing for the waste material to be expelled from the waste collection container 10.

In some embodiments of the mobile system 102, the bottom surface or floor (e.g., the surface on which the waste material is supported) of the waste collection container 10 is a solid, or substantially solid, structure (e.g., a plate, sheet, etc.). In some embodiments of the mobile system 102, the bottom surface or floor of the waste collection container 10 is a so-called “walking floor” comprising a conveyor-like structure that is used to empty the waste material from the waste collection container 10.

In the example mobile system 102, the roller compactor 200 comprises a boom arm 210, a stick arm, and a roller head assembly 230. The boom arm 210 is attached to the waste collection container 10 at a position that allows for the boom arm 210 to pivot in a vertical plane and swivel in a horizontal plane. The pivoting movement of the boom arm 210 is controlled by the actuator 212. The stick arm 220 is pivotably attached to the boom arm 210 at a distal end of the boom arm 210, opposite the proximal end of the boom arm 210 where the boom arm 210 is attached to the waste collection container 10. The roller compactor 200 comprises a second actuator extending between the boom arm 210 and the stick arm 220 for controlling, by an extension or retraction of the second actuator, a pivoting movement of the stick arm 220 about the distal end of the boom arm 210. The roller head assembly 230 is attached, at a distal end of the stick arm 220, to the stick arm 220. The roller head assembly 230 has a rigid frame, by which the roller head is attached to the stick arm 220. The rigid frame of the roller head assembly 230 is mobile relative to the stick arm 220. For example, the rigid frame may pivot (e.g., rotate in the plane shown in FIG. 3) about the distal end of the stick arm 220, swivel (e.g., rotate in the plane defined by the longitudinal axis of the stick arm 220 and the direction perpendicular to the plane shown in FIG. 3) about the distal end of the stick arm 220, and/or rotate with respect to the longitudinal axis of the stick arm 220. In some embodiments, the roller compactor 200 can have a pivotable, swivelable, and/or rotatable wrist structure, by which the roller head assembly 230 can be attached to the stick arm 220. In some embodiments, the boom arm 210 and/or the stick arm 220 are telescoping arms, with an adjustable length.

The roller compactor 200 is not in any way limited to having only a boom arm 210 and a stick arm 220. Instead, the roller compactor 200 can have any suitable construction, quantity, and type of arms, arm segments, sections, and the like. A nonlimiting example of such arms or arm segments includes one or more telescoping arms or telescoping arm segments. These arms, arm segments, and sections can move in relation to each other in any suitable manner based on the design of the roller compactor 200.

The roller head assembly 230 comprises, in some embodiments, a multi-ton roller head that is rotatably attached to the rigid frame. The roller head has agitators (e.g., spiked teeth) attached to the outer circumferential surface of the roller head. These agitators are shaped and attached to the outer circumferential wall of the roller head to compact and shred virtually any type of bulky waste material into smaller pieces that are more readily compressible with smaller total void area (e.g., having a greater density) within the waste collection container 10. The roller head of the roller head assembly 230 can be either self-powered or unpowered.

In a self-powered embodiment, the roller head assembly 230 can be operably attached to a power source (e.g., hydraulic, pneumatic, or electric) of the waste collection container 10. The power source can be used to move not only the roller head of the roller head assembly 230, but also to move the boom arm 210 relative to the waste collection container 10, to move the stick arm 220 relative to the boom arm 210, and to move the rigid frame of the roller head assembly 230 relative to the stick arm 220. In some self-powered embodiments, the roller head assembly 230 includes an energy storage unit, such as a battery, a motor, and/or a controller configured to receive wireless data transmissions for controlling operation of the roller head.

In the unpowered embodiment, the roller head is not rotatably driven relative to the rigid frame of the roller head assembly 230. Instead, the weight of the roller head is used to exert a compacting force on the waste material, the compacting force acting, for example, in a generally downward direction and the roller head assembly 230 is moved forward-reverse, left-right, and/or up-down by the boom arm 210 and the stick arm 220 of the roller compactor 200, such that the roller head spins as a result of the frictional contact of the roller head 230 with the waste material while the roller head assembly 230 is being moved within the waste collection container 10 by the boom arm 210 and stick arm 220.

In some embodiments, the roller compactor 200 is configured such that the roller head assembly 230 can be positioned external to the waste collection container 10 during loading of the waste material into the waste collection container 10 and during removal of the waste material from the waste collection container 10. An example schematic illustration showing the roller head assembly 230 external from the waste collection container is shown in FIG. 4. Optionally, the waste collection container 10 can be provided with a storage structure configured to hold the roller head assembly 230 in a designated location when not in use, so that the roller head assembly 230 does not interfere with the loading/unloading of the waste material into/from the waste collection container 10. In some such embodiments, the storage structure comprises an electrical charger configured to transfer electrical power to the energy storage unit of the roller head assembly 230 (e.g., only while the roller head assembly 230 is positioned in, such as in via direct contact with, electrical contacts provided within the storage structure).

In the example embodiment of the mobile system 102 disclosed herein, the waste collection container 10 is configured as an open-top container, but is not necessarily limited to such configurations; as such, the waste collection container 10 can be any suitable type of container. In some embodiments, the waste collection container 10 can be a structure that is not analogous to a conventional container, at least as such term may be used to conventionally describe a dumpster.

FIG. 4 shows another example embodiment of a mobile system, generally designated 104, in which a waste collection container 10 is pivotably attached to a vehicle, such as transport truck 40. The waste collection container 10 shown in FIG. 4 is substantially similar to the waste collection container shown in FIG. 3. Thus, the mobile system 104 comprises a transport truck 40, a waste collection container 10, and a roller compactor, generally designated 200. The mobile system 104 does not, unlike in mobile system 100, include a horizontal compactor (300, FIG. 1), since the waste material in the waste collection container 10 of FIG. 2 can be unloaded using the force of gravity, such as by rotating the waste collection container 10 from a horizontal position into the inclined position shown in FIG. 2. In the mobile system 104, the waste collection container 10 comprises a door 14 that is pivotably attached at a rear end, or surface, of the waste collection container 10, preferably at a top edge of the waste collection container 10. In this example, the roller compactor 200 is attached to a front end, or surface, of the waste collection container 10 from the rear end where the door 14 is attached to the waste collection container 10.

The transport truck 40 is configured as a dump truck, in which the waste collection container 10 is attached to the transport truck 40 in a manner that allows the waste collection container 10 to pivot about an axis of rotation R. In the mobile system 104, the waste collection container 10 can be permanently or removably attached to the transport truck 40 during transport of the waste material within the waste collection container 10 to and/or from a waste disposal and/or collection site. Since the mobile system 104 does not have a horizontal compactor, the mobile system 104 relies on gravity-driven unloading of the waste material from the waste collection container 10 upon the waste collection container 10 being pivoted about the axis of rotation R into an inclined position (e.g., in the clockwise direction in the view shown in FIG. 4). While the transport truck 40 is disclosed in this example embodiment as being configured as a dump truck, in some other embodiments, the transport truck 40 may be configured as flat-bed trucks (e.g., trucks that cannot pivot the waste collection container); in such embodiments, a waste collection container 10 having a horizontal compactor (e.g., 300, see FIG. 3), or a similar device or system (e.g., a walking floor) is advantageously utilized for unloading the waste material from the waste collection container 10. Thus, in some embodiments, the waste collection container 10 of the mobile system 104 may have, for example, a horizontal compactor and/or a walking floor for unloading the waste material from the waste collection container 10 thereof. In some embodiments, the roller compactor 200 can be used to expel the waste material from the waste collection container 10 by rotating the roller head of the roller head assembly within the waste collection container 10 against the waste material contained therein, the direction of rotation being in the direction that drives the waste material being contacted by the roller head towards the exit (e.g., door 14) of the waste collection container 10.

Pivoting of the door 14 relative to the waste collection container 10 can be actively or passively driven. In an actively driven embodiment, the pivoting movement of the door 14 is controlled by, for example and without limitation, an actuator, arm, linkage, etc. that moves the door 14 relative to the waste collection container 10. In a passively driven embodiment, the door 14 pivots freely relative to the waste collection container 10 and generally pivots into a position such that the door 14 is coaxial with the gravity vector. A hook, latch, release, etc. may be provided in either embodiment for securing the door 14 during, for example, transport of the waste collection container 10 to prevent unwanted opening of the door 14. The provision of an actively driven door 14 is particularly advantageously used in embodiments in which waste collection container 10 is intended for use on a truck that is not a dump truck. The reason for this is because a horizontal compactor or other device would have to exert a force of sufficient magnitude to also cause the door 14 to pivot into the open position, allowing for the waste material to be expelled from the waste collection container 10.

In some embodiments of the mobile system 104, the bottom surface or floor (e.g., the surface on which the waste material is supported) of the waste collection container 10 is a solid, or substantially solid, structure (e.g., a plate, sheet, etc.). In some embodiments of the mobile system 104, the bottom surface or floor of the waste collection container 10 is a so-called “walking floor” comprising a conveyor-like structure that is used to empty the waste material from the waste collection container 10.

In the example mobile system 104, the roller compactor 200 comprises a boom arm 210, a stick arm 220, and a roller head assembly 230. The boom arm 210 is attached to the waste collection container 10 at a position that allows for the boom arm 210 to pivot in a vertically-extending plane and swivel in a horizontally-extending plane. The pivoting movement of the boom arm 210 is controlled by the actuator 212. The stick arm 220 is pivotably attached to the boom arm 210 at a distal end of the boom arm 210, opposite the proximal end of the boom arm 210 where the boom arm 210 is attached to the waste collection container 10. The roller compactor 200 comprises a second actuator extending between the boom arm 210 and the stick arm 220 for controlling, by an extension or retraction of the second actuator, a pivoting movement of the stick arm 220 about the distal end of the boom arm 210. The roller head assembly 230 is attached, at a distal end of the stick arm 220, to the stick arm 220. The roller head assembly 230 has a rigid frame, by which the roller head is attached to the stick arm 220. The rigid frame of the roller head assembly 230 is mobile relative to the stick arm 220. For example, the rigid frame may pivot (e.g., rotate in the plane shown in FIG. 4) about the distal end of the stick arm 220, swivel (e.g., rotate in the plane defined by the longitudinal axis of the stick arm 220 and the direction perpendicular to the plane shown in FIG. 4) about the distal end of the stick arm 220, and/or rotate with respect to the longitudinal axis of the stick arm 220. In some embodiments, the roller compactor 200 can have a pivotable, swivelable, and/or rotatable wrist structure, by which the roller head assembly 230 can be attached to the stick arm 220. In some embodiments, the boom arm 210 and/or the stick arm 220 are telescoping arms, with an adjustable length.

The roller compactor 200 is not in any way limited to having only a boom arm 210 and a stick arm 220. Instead, the roller compactor 200 can have any suitable construction, quantity, and type of arms, arm segments, sections, and the like. A nonlimiting example of such arms or arm segments includes one or more telescoping arms or telescoping arm segments. These arms, arm segments, and sections can move in relation to each other in any suitable manner based on the design of the roller compactor 200.

The roller head assembly 230 comprises, in some embodiments, a multi-ton roller head that is rotatably attached to the rigid frame. The roller head has agitators (e.g., spiked teeth) attached to the outer circumferential surface of the roller head. These agitators are shaped and attached to the outer circumferential wall of the roller head to compact and shred virtually any type of bulky waste material into smaller pieces that are more readily compressible with smaller total void area (e.g., having a greater density) within the waste collection container 10. The roller head of the roller head assembly 230 can be either self-powered or unpowered.

In a self-powered embodiment, the roller head assembly 230 can be operably attached to a power source (e.g., hydraulic, pneumatic, or electric) of the waste collection container 10. The power source can be used to move not only the roller head of the roller head assembly 230, but also to move the boom arm 210 relative to the waste collection container 10, to move the stick arm 220 relative to the boom arm 210, and to move the rigid frame of the roller head assembly 230 relative to the stick arm 220. In some self-powered embodiments, the roller head assembly 230 includes an energy storage unit, such as a battery, a motor, and/or a controller configured to receive wireless data transmissions for controlling operation of the roller head.

In the unpowered embodiment, the roller head is not rotatably driven relative to the rigid frame of the roller head assembly 230. Instead, the weight of the roller head is used to exert a compacting force on the waste material, the compacting force acting, for example, in a generally downward direction and the roller head assembly 230 is moved forward-reverse, left-right, and/or up-down by the boom arm 210 and the stick arm 220 of the roller compactor 200, such that the roller head spins as a result of the frictional contact of the roller head 230 with the waste material while the roller head assembly 230 is being moved within the waste collection container 10 by the boom arm 210 and stick arm 220.

In some embodiments, the roller compactor 200 is configured such that the roller head assembly 230 can be positioned external to the waste collection container 10 during loading of the waste material into the waste collection container 10 and during removal of the waste material from the waste collection container 10. The roller head assembly 230 is shown external from the waste collection container 10 in FIG. 4. Optionally, the waste collection container 10 can be provided with a storage structure configured to hold the roller head assembly 230 in a designated location when not in use, so that the roller head assembly 230 does not interfere with the loading/unloading of the waste material into/from the waste collection container 10. In some such embodiments, the storage structure comprises an electrical charger configured to transfer electrical power to the energy storage unit of the roller head assembly 230 (e.g., only while the roller head assembly 230 is positioned in, such as in via direct contact with, electrical contacts provided within the storage structure).

In the example embodiment of the mobile system 104 disclosed herein, the waste collection container 10 is configured as an open-top container, but is not necessarily limited to such configurations; as such, the waste collection container 10 can be any suitable type of container. In some embodiments, the waste collection container 10 can be a structure that is not analogous to a conventional container, at least as such term may be used to conventionally describe a dumpster.

In the example embodiment of the mobile system 104, the transport truck 40 is a lift-back truck, by which the waste collection container 10 is configured to be pivoted about an axis of rotation R to facilitate dumping waste material out of the waste collection container 10. The waste collection container 10 is advantageously only temporarily attached to the transport truck 40 (e.g., in a manner so as to be readily and repeatedly moved onto and off of the transport truck 40) in the mobile system 104.

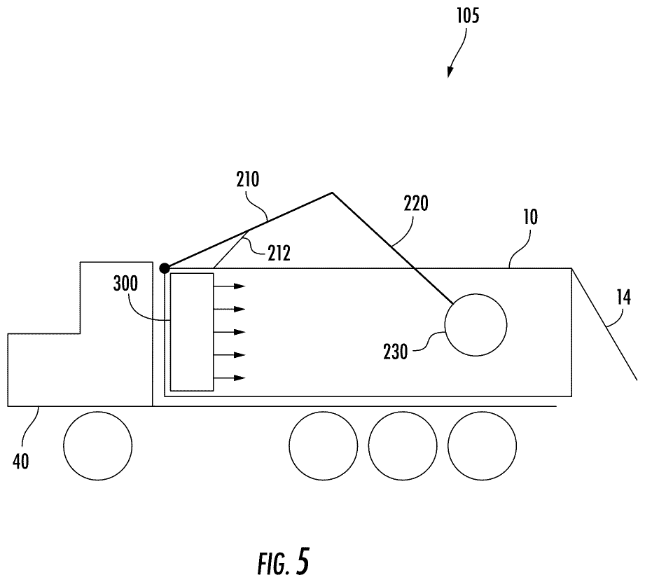

In some embodiments, conventionally known roll-off trucks may be used to load a stand-alone waste collection container, such as is shown in FIG. 5 for another example embodiment of a mobile system, generally designated 105, which comprises a roller compactor, generally designated 200. In some embodiments the mobile system 105 comprises a waste loader. In the example embodiment of mobile system 105, the waste collection container 10 is pulled onto the transport truck 40 and the waste collection container 10 is connected to a power source (e.g., electrical, pneumatic, and/or hydraulic) via quick disconnects to the power take-off (PTO) and electrical system of the transport truck 40. Such a waste collection container 10 can be unloaded from the transport truck 40 in a conventional manner, such as is done at present for conventional roll-off dumpsters by conventional roll-off trucks. The waste collection container 10 shown in FIG. 5 can be, for example and without limitation, substantially similar (e.g., identical) to either of the waste collection containers 10 in the mobile systems 100, 102 shown in FIGS. 1 and 3, respectively.

In some embodiments, the mobile systems 100, 102 can be attached to a trailer that is towable behind a vehicle (e.g., a truck), the waste collection container 10 of the mobile system 100, 102 being pivotably attached to the trailer and/or having a walking floor. In some embodiments, the mobile systems 100, 102 disclosed herein are configured to be used in conjunction with conventional roll-off trucks that are retrofit to have mobile systems 100, 102 attached thereto.

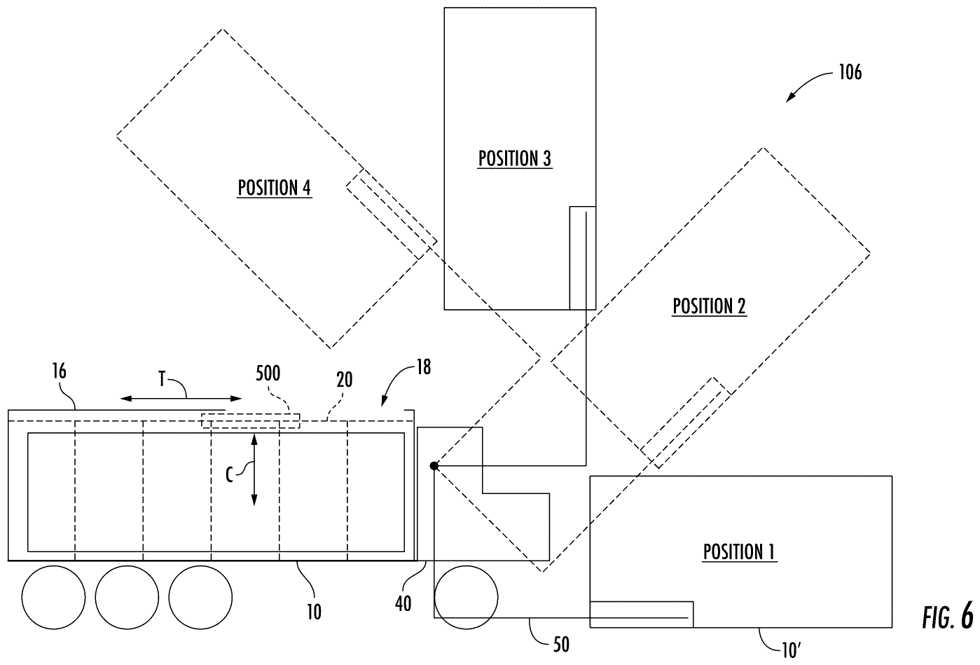

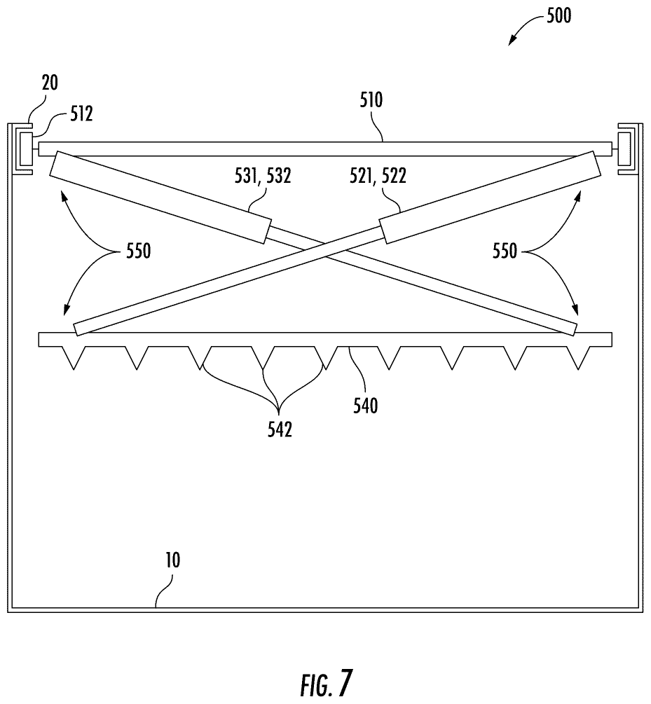

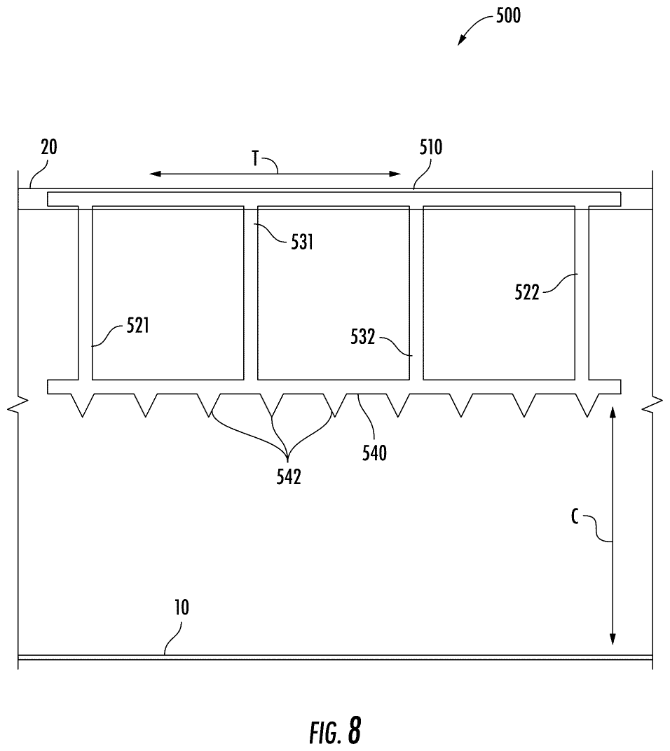

Another example embodiment of a mobile system, generally designated 106, is illustrated schematically in FIG. 6. Aspects of the example waste compactor 500 used in the mobile system 106 are shown in FIGS. 7 and 8. As shown in FIG. 6, the mobile system 106 comprises a transport truck 40, a waste collection container 10 attached to the transport truck 40 (e.g., in the manner of a bed of the truck) and a set of lift forks 50 operably attached to the transport truck 40, so as to be pivotable about the point where the lift forks 50 are attached to the transport truck 40. Movement of the lift forks 50 can be controlled and generated using any suitable power source, including, for example and without limitation, hydraulics, pneumatics, electric motors, and the like. The lift forks 50 are spaced apart from each other by a prescribed distance (e.g., substantially the same as the distance between the pockets shown in the waste container 10′ of FIG. 6) so as to engage within the pockets of a waste container 10′.

The waste collection container 10 is located behind an occupant compartment (e.g., “cab”) of the transport truck 40. The waste collection container 10 has at least a front wall and lateral or side walls that are substantially solid and/or rigid. In some embodiments, the rear wall and/or the bottom wall of the waste collection container 10 may also be substantially solid and/or rigid. In some embodiments, all of the front wall, the lateral or side walls, the rear wall, and the bottom wall of the waste collection container 10 may be substantially continuous and uninterrupted. In some embodiments, the rear wall can be configured as a door (e.g., 14, FIGS. 1-4) that is attached (e.g., pivotably) to the lateral or side walls and/or the top wall or the bottom wall of the waste collection container 10, such as in the manner of a dump bed of a dump truck. The top wall 16 of the waste collection container 10 encloses the top of the waste collection container 10, with the exception of an opening, generally designated 18, formed in the top wall 16. Thus, the top surface can be continuous and uninterrupted with the sole exception of the opening 18.

Once engaged within the pockets of a waste container 10′, the lift forks 50 are pivoted about the attachment point (e.g., where the lift forks 50 are attached to the transport truck 40), lifting the waste container 10′ from position 1 and sequentially through position 2, position 3, and position 4 for transferring the waste material from the waste container 10′ into the waste collection container 10. The position and dimensions of the opening 18 in the top wall 16 of the waste collection container 10 are such that the waste material can fall, starting when the waste container 10′ is at or about at the position designated as “position 3” in FIG. 6, into the waste collection container 10 through the opening 18. The opening 18 is advantageously large enough to capture substantially all of the waste material as it falls out of the waste container 10′ in the direction of the waste collection container 10. The transfer of the waste material from the waste container 10′ into the waste collection container 10 is advantageously accomplished using gravity (e.g., by positioning the waste material higher than the opening 18, such that the waste material falls through the opening 18 due to the force exerted on the waste material by the force of gravity).

The mobile system 106 also comprises, contained within the waste collection container 10, a waste compactor 500. The waste compactor 500 is movably positioned within the waste collection container 10. The waste compactor 500 itself, as well as the direction of compaction of the waste material and the direction of travel of the waste compactor 500 within the waste collection container 10, are shown schematically in FIG. 6. Further aspects of the waste compactor 500 of the mobile system 106 are shown in FIGS. 7 and 8, which will be described further herein.

The waste compactor 500 is shown in greater detail in FIGS. 7 and 8. The waste compactor 500 is movably attached to the interior of the waste collection container 10 by a pair of rails 20 that are rigidly attached at or adjacent to the top (e.g., in the vertical direction, in the orientation shown in FIGS. 7 and 8) surface, wall, edge, etc. of the waste collection container 10. Each rail 20 is attached on an opposite wall of the waste collection container 10. In the example embodiment shown in FIGS. 7 and 8, the rails 20 are attached, respectively, to the lateral or side walls of the waste collection container 10. The waste compactor 500 is movably retained in the rails 20 by wheels 512 that are attached to an upper plate 510 of the waste compactor 500, the wheels 512 being driven wheels, idler wheels, or a combination of both driven wheels and idler wheels. The wheels 512 are configured for moving the waste compactor 500 along the length of the waste collection container 10 (e.g., along the longitudinal axis of the waste collection container 10, which is perpendicular to the cut-plane shown in FIG. 7). The waste compactor 500 also comprises a compaction plate 540, disposed beneath (e.g., in the vertical direction, in the orientation shown in FIGS. 7 and 8) the upper plate 510.

The compaction plate 540 is attached to the upper plate 510 by a plurality of cylinders 521, 522, 531, 532. In order to prevent a cocking movement of the compaction plate 540 with respect to the upper plate 510, the plurality of cylinders 521, 522, 531, 532 comprises a plurality of first cylinders 521, 522 and a plurality of second cylinders 531, 532, which can be attached to the upper plate 510 and the compaction plate 540 in, for example, an alternating or staggered arrangement. In the example embodiment shown in FIGS. 7 and 8, the waste compactor has the plurality of second cylinders 531, 532 attached between, with respect to the longitudinal axis, the plurality of first cylinders 521, 522.

A first end of each of the plurality of first cylinders 521, 522 is attached to (e.g., at or adjacent to) an edge of the upper plate 510 that is opposite the edge of the upper plate 519 to which a first end of each of the plurality of second cylinders 531, 532 is attached (e.g., at or adjacent to). The plurality of first cylinders 521, 522 extend such that, at a second end of each of the plurality of first cylinders 521, 522, the plurality of first cylinders 521, 522 are attached to (e.g., at or adjacent to) an edge of the compaction plate 540 that is closest to the edge of the upper plate 510 to which the first ends of the plurality of second cylinders 531, 532 are attached. The plurality of second cylinders 531, 532 extend such that, at a second end of each of the plurality of second cylinders 531, 532, the plurality of second cylinders 531, 532 are attached to (e.g., at or adjacent to) an edge of the compaction plate 540 that is closest to the edge of the upper plate 510 to which the first ends of the plurality of first cylinders 521, 522 are attached. Thus, each of the plurality of first cylinders 521, 522 is attached between opposing edges of the upper plate 510 and the compaction plate 540 and each of the plurality of second cylinders 531, 532 is attached between opposing edges of the upper plate 510 and the compaction plate 540. This attachment scheme results, when viewed along the longitudinal axis (e.g., along the view shown in FIG. 7), in the plurality of first cylinders 521, 522 and the plurality of second cylinders 531, 532 forming an “X” shape.

The cylinders of the plurality of first cylinders 521, 522 and second cylinders 531, 532 can be any suitable device capable of causing a movement of the compaction plate 540 with respect to the upper plate 510. In the example embodiment shown in FIGS. 7 and 8, the plurality of cylinders 521, 522, 531, 532 are hydraulically- and/or pneumatically-driven cylinders. The waste compactor 500 is configured to operate by extending and retracting the plurality of first cylinders 521, 522 and the plurality of second cylinders 531, 532 to move the compaction plate 540 with respect to the upper plate 510. Each of the plurality of first cylinders 521, 522 and the plurality of second cylinders 531, 532 can be controlled independently, so as to exert a lower or higher compressive force on the compaction plate 540 such as, for example, to maintain a substantially parallel orientation between the upper plate 510 and the compaction plate 540 during movement of the compaction plate 540 in the compaction direction C, such as when the waste compactor 500 is being used to compact the waste material within the waste collection container 10.

The waste compactor 500 also comprises, attached to the compaction plate 540 thereof, a plurality of agitators 542 for breaking apart, crushing, splintering, etc. the bulky waste material into smaller pieces that can fill the waste collection container 10 with a higher density than the uncompacted waste material. A non-limiting example of such agitators 542 can be a generally conically-shaped element protruding from the bottom surface of the compaction plate 540. The agitators 542 can be passive (e.g., stationary) and/or active (e.g., having some kinetic motion aspect, such as a rotary and/or axial motion) without limitation. The waste compactor 500 may be used while the waste collection container 10 (and transport truck 40, as applicable) is in motion or while stationary. While the illustration of FIG. 8 is of only a portion of the waste collection container 10, the waste compactor 500 is advantageously capable of movement in the transit direction T along an entire length of the waste collection container 10 for compacting the waste material along the entire length of the waste collection container 10. In some embodiments, the compaction plate 540 and/or the agitators 542 may have a vibratory excitation mode for breaking apart and/or compacting the waste material while the compaction plate 540 and/or the agitators 542 are, as the case may be, in contact with the waste material. The waste collection container 10 can be fixedly attached to the transport truck 40 in some embodiments. In some other embodiments, the waste collection container 10 can be a “roll-off” style waste collection container 10, in which case the waste collection container 10 is removably secured to the transport truck 40 but can be readily moved onto and off of the transport truck 40. Thus, the example mobile system 106 disclosed in FIGS. 6-8 can have a transport truck 40 that is, in some embodiments, a conventional roll-off style truck.

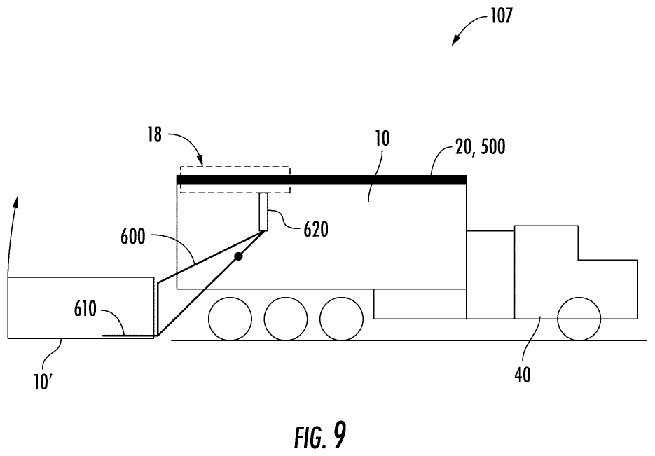

FIG. 9 schematically shows a further example embodiment of a mobile system, generally designated 107, which is generally similar to the example embodiment of the mobile system 105, aspects of which are shown in FIGS. 6-8. However, the mobile system 106 is configured to access and load the waste material into the waste collection container 10 from a waste container 10′ that is positioned at the rear of (e.g., behind) the transport truck 40. To accomplish this, the waste collection container 10 is substantially similar to the waste collection container 10 disclosed and described in mobile system 106, example aspects of which are shown in FIGS. 6-8; however, the opening 18 formed in the top surface of the waste collection container 10 is at, or adjacent to, a rear of the waste collection container 10 (e.g., at the end that is farthest from the passenger compartment of the transport truck 40).

As shown in FIG. 9, the mobile system 107 comprises a transport truck 40, a waste collection container 10 attached to the transport truck 40 (e.g., in the manner of a bed of the truck), and a lifter 600 comprising, for example, a set of lift forks 610. The lifter 600 is operably attached to the transport truck 40, so as to be pivotable about the point where the lifter 600 is attached to the transport truck 40. Movement of the lifter 600 can be controlled and generated using any suitable power source, including, for example and without limitation, hydraulics, pneumatics, electric motors, and the like. In the example embodiment, the movement of the lifter 600 is controlled using the actuator 620. In some embodiments, the actuator 620 can be a cylinder, which can be the same as or different from the cylinders 521, 522, 531, 532 shown in FIGS. 7 and 8. The lift forks 50 are spaced apart from each other by a prescribed distance (e.g., substantially the same as the distance between the pockets shown in the waste container 10′ of FIG. 9) so as to engage within the pockets of a waste container 10′.

The waste collection container 10 is located behind an occupant compartment (e.g., “cab”) of the transport truck 40. The waste collection container 10 has at least a front wall and lateral or side walls that are substantially solid and/or rigid. In some embodiments, the rear wall and/or the bottom wall of the waste collection container 10 may also be substantially solid and/or rigid. In some embodiments, all of the front wall, the lateral or side walls, the rear wall, and the bottom wall of the waste collection container 10 may be substantially continuous and uninterrupted. In some embodiments, the rear wall can be configured as a door (e.g., 14, FIGS. 1-4) that is attached (e.g., pivotably) to the lateral or side walls and/or the top wall or the bottom wall of the waste collection container 10, such as in the manner of a dump bed of a dump truck. The top wall of the waste collection container 10 encloses the top of the waste collection container 10, with the exception of an opening, generally designated 18, formed in the top wall. Thus, the top surface can be continuous and uninterrupted with the sole exception of the opening 18.

Once engaged within the pockets of a waste container 10′, the lifter 600 is pivoted about the attachment point (e.g., where the lifter 600 is attached to the transport truck 40), lifting the waste container 10′ from the position shown in FIG. 9, in the direction of the arrow shown extending substantially vertically from the rear edge of the waste container 10′. The lifter 600 moves the waste container 10′ in a generally arced path around a pivot point. As the waste container 10′ is lifted to approach and/or exceed a vertical orientation, the waste material will fall from the waste container 10′ into the waste collection container 10 through the opening 18. The position and dimensions of the opening 18 of the waste collection container 10 are such that the waste material can fall into the waste collection container 10 through the opening 18. The opening 18 is advantageously large enough to capture substantially all of the waste material as it falls out of the waste container 10′ in the direction of the waste collection container 10. The transfer of the waste material from the waste container 10′ into the waste collection container 10 is advantageously accomplished using gravity (e.g., by positioning the waste material higher than the opening 18, such that the waste material falls through the opening 18 due to the force exerted on the waste material by the force of gravity).

The mobile system 107 also comprises, contained within the waste collection container 10, a waste compactor 500. The waste compactor 500 is movably positioned within the waste collection container 10. The waste compactor 500 is shown schematically in FIG. 9. The waste compactor 500 is mobile within and along the length of the waste collection container 10, moving within the rails 20 at the upper surface of the waste collection container 10m in the same manner as the waste compactor 500 of the mobile system 106, shown in FIGS. 6-8. Further example aspects of the waste compactor 500 of the mobile system 107 are shown in FIGS. 7 and 8, which is described elsewhere herein. Reference should be made to the description of the waste compactor 500 of the mobile system 106 hereinabove to understand the structure and functionality of the waste compactor 500 of the mobile system 107, since mobile systems 106, 107 use a substantially identical design for waste compactor 500.

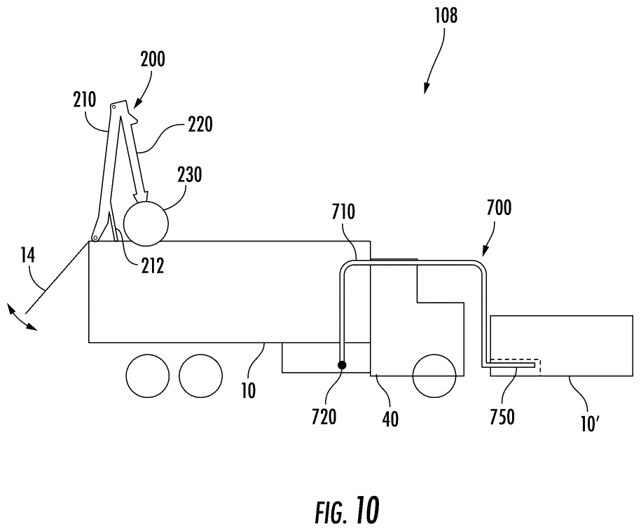

FIG. 10 schematically shows another example embodiment of a mobile system, generally designated 108. The mobile system 108 is substantially similar to that which is disclosed in FIG. 6, with the exception that the mobile system 108 of FIG. 10 does not utilize the waste compactor 500 shown in FIGS. 7 and 8, but instead comprises a waste compactor in the form of a roller compactor, generally designated 200. As shown in FIG. 10, the mobile system 108 comprises a transport truck 40, a waste collection container 10 attached to the transport truck 40 (e.g., in the manner of a bed of the truck) and a lifter, generally designated 700, operably attached to the transport truck 40, so as to be pivotable about the point where the lifter 700 is attached to the transport truck 40. In the example embodiment shown, the lifter 700 is in the form of a rigid frame 710 extending from a pivot point 720 and, attached to the frame 710, lift forks 750. Movement of the lifter 700 can be controlled and generated using any suitable power source, including, for example and without limitation, hydraulics, pneumatics, electric motors, and the like. In the example embodiment, lift forks 750 are spaced apart from each other by a prescribed distance (e.g., substantially the same as the distance between the pockets shown in the waste container 10′ of FIG. 6) so as to engage within the pockets of a waste container 10′.

The waste collection container 10 is located behind an occupant compartment (e.g., “cab”) of the transport truck 40. The waste collection container 10 has at least a front wall and lateral or side walls that are substantially solid and/or rigid. In some embodiments, the rear wall and/or the bottom wall of the waste collection container 10 may also be substantially solid and/or rigid. In some embodiments, all of the front wall, the lateral or side walls, the rear wall, and the bottom wall of the waste collection container 10 may be substantially continuous and uninterrupted. The top wall 16 of the waste collection container 10 is substantially open (e.g., more than 50%, at least 75%, at least 80%, at least 90%, or more than 95% open by area). In the example embodiment shown, the rear wall can be or define, in whole or in part, as a door 14. The door 14 is attached (e.g., pivotably) to the lateral or side walls and/or the top wall or the bottom wall of the waste collection container 10, such as in the manner of a dump bed of a dump truck.

Pivoting of the door 14 relative to the waste collection container 10 can be actively or passively driven. In an actively driven embodiment, the pivoting movement of the door 14 is controlled by, for example and without limitation, an actuator, arm, linkage, etc. that moves the door 14 relative to the waste collection container 10. In a passively driven embodiment, the door 14 pivots freely relative to the waste collection container 10 and generally pivots into a position such that the door 14 is coaxial with the gravity vector. A hook, latch, release, etc. may be provided in either embodiment for securing the door 14 during, for example, transport of the waste collection container 10 to prevent unwanted opening of the door 14. The provision of an actively driven door 14 is particularly advantageously used in embodiments in which waste collection container 10 is intended for use on a truck that is not a dump truck. The reason for this is because a horizontal compactor (e.g., 300, FIG. 1) or another device would, in such a configuration, not only have to exert a force sufficient to move the waste material towards the door 14, but would also have to exert a force of sufficient magnitude to also cause the door 14 to pivot into the open position, allowing for the waste material to be expelled from the waste collection container 10.

In some embodiments of the mobile system 108, the bottom surface or floor (e.g., the surface on which the waste material is supported) of the waste collection container 10 is a solid, or substantially solid, structure (e.g., a plate, sheet, etc.). In some embodiments of the mobile system 108, the bottom surface or floor of the waste collection container 10 is a so-called “walking floor” comprising a conveyor-like structure that is used to empty the waste material from the waste collection container 10.

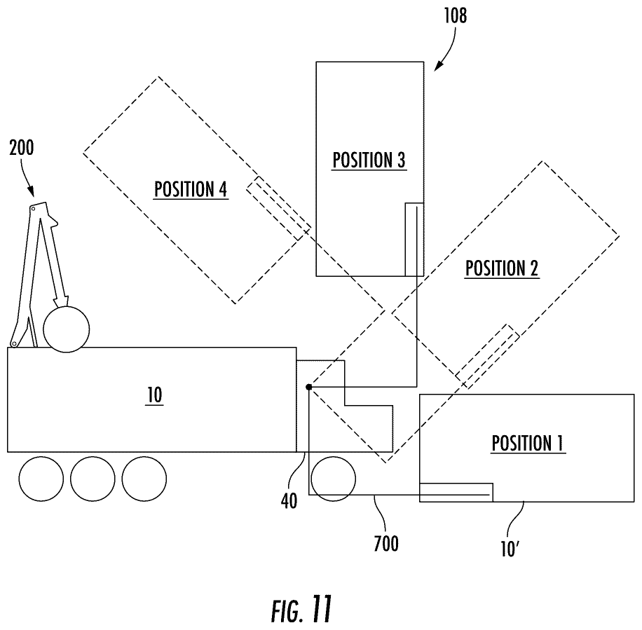

Once engaged within the pockets of a waste container 10′, the lift forks 750 and the frame 710 of the lifter 700 are pivoted about the attachment point (e.g., where the lift forks 50 are attached to the transport truck 40), lifting the waste container 10′ from the position shown in FIG. 10. The movement of the waste container 10′ is shown in FIG. 11. Thus, the lifter 700 lifts the waste container 10′ from position 1 and sequentially through position 2, position 3, and position 4 for transferring the waste material from the waste container 10′ into the waste collection container 10 of the mobile system 108. Since the top surface of the waste collection container 10 is substantially open, the waste material can fall, starting when the waste container 10′ is at or about at the position designated as “position 3” in FIG. 11, into the waste collection container 10. The transfer of the waste material from the waste container 10′ into the waste collection container 10 is advantageously accomplished using gravity (e.g., by positioning the waste material higher than the top surface of the waste collection container 10, such that the waste material falls into the waste collection container 10 due to the force exerted on the waste material by the force of gravity).

In the example mobile system 108, the roller compactor 200 is attached to a top edge of a rear wall of the waste collection container 10 (e.g., the wall furthest away from the cab of the transport truck 40) and comprises a boom arm 210, a stick arm, and a roller head assembly 230. The boom arm 210 is attached to the waste collection container 10 at a position that allows for the boom arm 210 to pivot in a vertical plane and swivel in a horizontal plane. The pivoting movement of the boom arm 210 is controlled by the actuator 212. The stick arm 220 is pivotably attached to the boom arm 210 at a distal end of the boom arm 210, opposite the proximal end of the boom arm 210 where the boom arm 210 is attached to the waste collection container 10. The roller compactor 200 comprises a second actuator extending between the boom arm 210 and the stick arm 220 for controlling, by an extension or retraction of the second actuator, a pivoting movement of the stick arm 220 about the distal end of the boom arm 210. The roller head assembly 230 is attached, at a distal end of the stick arm 220, to the stick arm 220. The roller head assembly 230 has a rigid frame, by which the roller head is attached to the stick arm 220. The rigid frame of the roller head assembly 230 is mobile relative to the stick arm 220. For example, the rigid frame may pivot (e.g., rotate in the plane shown in FIG. 10) about the distal end of the stick arm 220, swivel (e.g., rotate in the plane defined by the longitudinal axis of the stick arm 220 and the direction perpendicular to the plane shown in FIG. 10) about the distal end of the stick arm 220, and/or rotate with respect to the longitudinal axis of the stick arm 220. In some embodiments, the roller compactor 200 can have a pivotable, swivelable, and/or rotatable wrist structure, by which the roller head assembly 230 can be attached to the stick arm 220. In some embodiments, the boom arm 210 and/or the stick arm 220 are telescoping arms, with an adjustable length.

The roller compactor 200 is not in any way limited to having only a boom arm 210 and a stick arm 220. Instead, the roller compactor 200 can have any suitable construction, quantity, and type of arms, arm segments, sections, and the like. A nonlimiting example of such arms or arm segments includes one or more telescoping arms or telescoping arm segments. These arms, arm segments, and sections can move in relation to each other in any suitable manner based on the design of the roller compactor 200.

The roller head assembly 230 comprises, in some embodiments, a multi-ton roller head that is rotatably attached to the rigid frame. The roller head has agitators (e.g., spiked teeth) attached to the outer circumferential surface of the roller head. These agitators are shaped and attached to the outer circumferential wall of the roller head to compact and shred virtually any type of bulky waste material into smaller pieces that are more readily compressible with smaller total void area (e.g., having a greater density) within the waste collection container 10. The roller head of the roller head assembly 230 can be either self-powered or unpowered.

In a self-powered embodiment, the roller head assembly 230 can be operably attached to a power source (e.g., hydraulic, pneumatic, or electric) of the waste collection container 10. The power source can be used to move not only the roller head of the roller head assembly 230, but also to move the boom arm 210 relative to the waste collection container 10, to move the stick arm 220 relative to the boom arm 210, and to move the rigid frame of the roller head assembly 230 relative to the stick arm 220. In some self-powered embodiments, the roller head assembly 230 includes an energy storage unit, such as a battery, a motor, and/or a controller configured to receive wireless data transmissions for controlling operation of the roller head.

In the unpowered embodiment, the roller head is not rotatably driven relative to the rigid frame of the roller head assembly 230. Instead, the weight of the roller head is used to exert a compacting force on the waste material, the compacting force acting, for example, in a generally downward direction and the roller head assembly 230 is moved forward-reverse, left-right, and/or up-down by the boom arm 210 and the stick arm 220 of the roller compactor 200, such that the roller head spins as a result of the frictional contact of the roller head 230 with the waste material while the roller head assembly 230 is being moved within the waste collection container 10 by the boom arm 210 and stick arm 220.

In some embodiments, the roller compactor 200 is configured such that the roller head assembly 230 can be positioned external to the waste collection container 10 during loading of the waste material into the waste collection container 10 and during removal of the waste material from the waste collection container 10. Example schematic illustrations showing the roller head external from the waste collection container are shown in FIGS. 2 and 4. In the position shown in FIG. 10, the roller head assembly 230 is positioned partially external to the waste container 10. Optionally, the waste collection container 10 can be provided with a storage structure configured to hold the roller head assembly 230 in a designated location when not in use, so that the roller head assembly 230 does not interfere with the loading/unloading of the waste material into/from the waste collection container 10. In some such embodiments, the storage structure comprises an electrical charger configured to transfer electrical power to the energy storage unit of the roller head assembly 230 (e.g., only while the roller head assembly 230 is positioned in, such as in via direct contact with, electrical contacts provided within the storage structure).

In some embodiments, the waste collection container 10 of the mobile system 108 has a solid (i.e., rigid, substantially immovable) wall instead of the door 14.

FIG. 11 is a schematic illustration showing a lifting operation of the waste container for the waste transport and compaction system of FIG. 10, such that the waste material is transferred from the waste container into the waste collection container.

In the example embodiment of the mobile system 108 shown in FIGS. 10 and 11, the roller compactor 200 is mounted to the waste collection container 10 to compact bulky waste materials in the waste collection container 10. The transport truck 40 may be, in some embodiments and for example, a conventional front-load garbage truck, which uses lifting forks to lift and dump waste containers into the waste collection container through an opening in the forward area of the top surface of the waste collection container. Such front-load garbage trucks are used almost exclusively for municipal solid waste (e.g., ordinary household and commercial garbage). Such front-load garbage trucks typically employ a horizontal compactor (e.g., 300, FIG. 1), however, which are known to be slow to operate and minimally effective at compacting the types of bulky waste materials (e.g., pallets, furniture, and construction material) that are typically deposited in open-top dumpsters. Thus, the mobile system 108 comprises a roller compactor that is attached to the waste collection container 10 for rapidly compacting bulky waste material to a high degree of compaction than is possible using a horizontal compactor commonly used on such front-load garbage trucks, thereby minimizing job site cycle time and maximizing the amount of waste material that can be contained within the waste collection container 10.

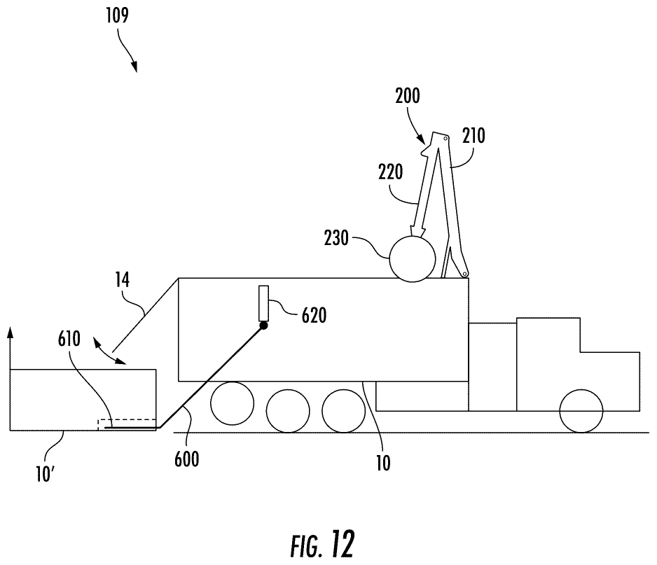

FIG. 12 schematically shows a further example embodiment of a mobile system, generally designated 109. The mobile system 109 is configured to access and load the waste material into the waste collection container 10 from a waste container 10′ that is positioned at the rear of (e.g., behind) the transport truck 40. To accomplish this, the waste collection container 10 is substantially similar to the waste collection container 10 disclosed and described in mobile system 107, example aspects of which are shown in FIG. 9, however, the waste collection container 10 has a substantially open top surface, meaning that, for example, more than 50%, at least 75%, at least 80%, at least 90%, or more than 95% of the top surface of the waste collection container 10 is open by area; thus, the waste collection container 10 of the mobile system 109 does not have the opening 18 of the waste collection container 10 of the mobile system 107.

As shown in FIG. 12, the mobile system 109 comprises a transport truck 40, a waste collection container 10 attached to the transport truck 40 (e.g., in the manner of a bed of the truck), and, optionally, a lifter 600 comprising, for example, a set of lift forks 610. The lifter 600 is operably attached to the transport truck 40, so as to be pivotable about the point where the lifter 600 is attached to the transport truck 40. Movement of the lifter 600 can be controlled and generated using any suitable power source, including, for example and without limitation, hydraulics, pneumatics, electric motors, and the like. In the example embodiment, the movement of the lifter 600 is controlled using the actuator 620. In some embodiments, the actuator 620 can be a cylinder, which can be the same as or different from the cylinders 521, 522, 531, 532 shown in FIGS. 7 and 8. The lift forks 610 are spaced apart from each other by a prescribed distance (e.g., substantially the same as the distance between the pockets shown in the waste container 10′ of FIG. 9) so as to engage within the pockets of a waste container 10′.

The waste collection container 10 is located behind an occupant compartment (e.g., “cab”) of the transport truck 40. The waste collection container 10 has at least a front wall and lateral or side walls that are substantially solid and/or rigid. In some embodiments, the rear wall and/or the bottom wall of the waste collection container 10 may also be substantially solid and/or rigid. In some embodiments, all of the front wall, the lateral or side walls, the rear wall, and the bottom wall of the waste collection container 10 may be substantially continuous and uninterrupted. In the example embodiment shown, the rear wall can be or define, in whole or in part, as a door 14. The door 14 is attached (e.g., pivotably) to the lateral or side walls and/or the top wall or the bottom wall of the waste collection container 10, such as in the manner of a dump bed of a dump truck.

Pivoting of the door 14 relative to the waste collection container 10 can be actively or passively driven. In an actively driven embodiment, the pivoting movement of the door 14 is controlled by, for example and without limitation, an actuator, arm, linkage, etc. that moves the door 14 relative to the waste collection container 10. In a passively driven embodiment, the door 14 pivots freely relative to the waste collection container 10 and generally pivots into a position such that the door 14 is coaxial with the gravity vector. A hook, latch, release, etc. may be provided in either embodiment for securing the door 14 during, for example, transport of the waste collection container 10 to prevent unwanted opening of the door 14. The provision of an actively driven door 14 is particularly advantageously used in embodiments in which waste collection container 10 is intended for use on a truck that is not a dump truck. The reason for this is because a horizontal compactor (e.g., 300, FIG. 1) or another device would, in such a configuration, not only have to exert a force sufficient to move the waste material towards the door 14, but would also have to exert a force of sufficient magnitude to also cause the door 14 to pivot into the open position, allowing for the waste material to be expelled from the waste collection container 10.

In some embodiments of the mobile system 108, the bottom surface or floor (e.g., the surface on which the waste material is supported) of the waste collection container 10 is a solid, or substantially solid, structure (e.g., a plate, sheet, etc.). In some embodiments of the mobile system 108, the bottom surface or floor of the waste collection container 10 is a so-called “walking floor” comprising a conveyor-like structure that is used to empty the waste material from the waste collection container 10.

Once engaged within the pockets of a waste container 10′, the lifter 600 is pivoted about the attachment point (e.g., where the lifter 600 is attached to the transport truck 40), lifting the waste container 10′ from the position shown in FIG. 12, in the direction of the arrow shown extending substantially vertically from the rear edge of the waste container 10′. The lifter 600 moves the waste container 10′ in a generally arced path around a pivot point. As the waste container 10′ is lifted to approach and/or exceed a vertical orientation, the waste material will fall from the waste container 10′ into the waste collection container 10. Since the top surface of the waste collection container 10 is substantially open, the waste material can fall, starting when the waste container 10′ is at or about at the position designated as “position 3” in FIG. 11, into the waste collection container 10. The transfer of the waste material from the waste container 10′ into the waste collection container 10 is advantageously accomplished using gravity (e.g., by positioning the waste material higher than the top surface of the waste collection container 10, such that the waste material falls into the waste collection container 10 due to the force exerted on the waste material by the force of gravity).

The mobile system 109 also comprises, contained within the waste collection container 10, a roller compactor, generally designated 200. The roller compactor 200 is attached to a top edge of a front wall of the waste collection container 10 (e.g., the wall closest to the cab of the transport truck 40) and comprises a boom arm 210, a stick arm, and a roller head assembly 230. The boom arm 210 is attached to the waste collection container 10 at a position that allows for the boom arm 210 to pivot in a vertical plane and swivel in a horizontal plane. The pivoting movement of the boom arm 210 is controlled by the actuator 212. The stick arm 220 is pivotably attached to the boom arm 210 at a distal end of the boom arm 210, opposite the proximal end of the boom arm 210 where the boom arm 210 is attached to the waste collection container 10. The roller compactor 200 comprises a second actuator extending between the boom arm 210 and the stick arm 220 for controlling, by an extension or retraction of the second actuator, a pivoting movement of the stick arm 220 about the distal end of the boom arm 210. The roller head assembly 230 is attached, at a distal end of the stick arm 220, to the stick arm 220. The roller head assembly 230 has a rigid frame, by which the roller head is attached to the stick arm 220. The rigid frame of the roller head assembly 230 is mobile relative to the stick arm 220. For example, the rigid frame may pivot (e.g., rotate in the plane shown in FIG. 10) about the distal end of the stick arm 220, swivel (e.g., rotate in the plane defined by the longitudinal axis of the stick arm 220 and the direction perpendicular to the plane shown in FIG. 10) about the distal end of the stick arm 220, and/or rotate with respect to the longitudinal axis of the stick arm 220. In some embodiments, the roller compactor 200 can have a pivotable, swivelable, and/or rotatable wrist structure, by which the roller head assembly 230 can be attached to the stick arm 220. In some embodiments, the boom arm 210 and/or the stick arm 220 are telescoping arms, with an adjustable length.

The roller compactor 200 is not in any way limited to having only a boom arm 210 and a stick arm 220. Instead, the roller compactor 200 can have any suitable construction, quantity, and type of arms, arm segments, sections, and the like. A nonlimiting example of such arms or arm segments includes one or more telescoping arms or telescoping arm segments. These arms, arm segments, and sections can move in relation to each other in any suitable manner based on the design of the roller compactor 200.

The roller head assembly 230 comprises, in some embodiments, a multi-ton roller head that is rotatably attached to the rigid frame. The roller head has agitators (e.g., spiked teeth) attached to the outer circumferential surface of the roller head. These agitators are shaped and attached to the outer circumferential wall of the roller head to compact and shred virtually any type of bulky waste material into smaller pieces that are more readily compressible with smaller total void area (e.g., having a greater density) within the waste collection container 10. The roller head of the roller head assembly 230 can be either self-powered or unpowered.

In a self-powered embodiment, the roller head assembly 230 can be operably attached to a power source (e.g., hydraulic, pneumatic, or electric) of the waste collection container 10. The power source can be used to move not only the roller head of the roller head assembly 230, but also to move the boom arm 210 relative to the waste collection container 10, to move the stick arm 220 relative to the boom arm 210, and to move the rigid frame of the roller head assembly 230 relative to the stick arm 220. In some self-powered embodiments, the roller head assembly 230 includes an energy storage unit, such as a battery, a motor, and/or a controller configured to receive wireless data transmissions for controlling operation of the roller head.

In the unpowered embodiment, the roller head is not rotatably driven relative to the rigid frame of the roller head assembly 230. Instead, the weight of the roller head is used to exert a compacting force on the waste material, the compacting force acting, for example, in a generally downward direction and the roller head assembly 230 is moved forward-reverse, left-right, and/or up-down by the boom arm 210 and the stick arm 220 of the roller compactor 200, such that the roller head spins as a result of the frictional contact of the roller head 230 with the waste material while the roller head assembly 230 is being moved within the waste collection container 10 by the boom arm 210 and stick arm 220.

In some embodiments, the roller compactor 200 is configured such that the roller head assembly 230 can be positioned external to the waste collection container 10 during loading of the waste material into the waste collection container 10 and during removal of the waste material from the waste collection container 10. Example schematic illustrations showing the roller head external from the waste collection container are shown in FIGS. 2 and 4. In the position shown in FIG. 12, the roller head assembly 230 is positioned partially external to the waste container 10. Optionally, the waste collection container 10 can be provided with a storage structure configured to hold the roller head assembly 230 in a designated location when not in use, so that the roller head assembly 230 does not interfere with the loading/unloading of the waste material into/from the waste collection container 10. In some such embodiments, the storage structure comprises an electrical charger configured to transfer electrical power to the energy storage unit of the roller head assembly 230 (e.g., only while the roller head assembly 230 is positioned in, such as in via direct contact with, electrical contacts provided within the storage structure).

In some embodiments, the waste collection container 10 of the mobile system 109 has a solid (i.e., rigid, substantially immovable) wall instead of the door 14.

The waste collection container 10 of the mobile system 109 can be permanently mounted to the transport truck 40 or can be pulled on and off a roll-off style truck in the same manner as a standard roll-off dumpster is pulled on and off of a conventional roll-off style truck. By allowing for the use of roll-off style trucks in the mobile system 109, current operators of such roll-off style trucks can utilize their current fleets of such trucks to service an inventory of conventional dumpsters, as well as using the same roll-off style trucks to service an inventory of the smaller waste containers disclosed herein (see, e.g., FIGS. 6 and 7). When using a roll-off style truck, quick-connect hydraulics may be used to connect the waste collection container to the truck's hydraulic system. However, by using a permanent attachment of the waste collection container 10 to the transport truck 40, the payload of the transport truck 40 will be increased in comparison to a roll-off style truck because the mass of the roll-off apparatus required to slide a roll-off container on and off of the transport truck 40 is eliminated.

The frame 710 of the lifter 700 can use straight or curved arms, which are similar to those used by conventional front-load trucks. The lifting arms can employ any suitable design. Similarly, the cylinders that raise and lower the lifting apparatus can be vertically oriented, inclined at an angle, or have any other suitable configuration. The waste collection container 10 may be reinforced with vertical (e.g., steel or other suitable material) members to provide strength and rigidity to the waste collection container 10 to support the mass of the roller compactor 200 and to resist deformation from the forces acting on the waste collection 10 container during compaction of the waste material contained therein by the roller compactor 200.

The roller compactor 200 is mounted at the rear of the waste collection container to not interfere with the dumping of the waste material from the waste container 10′ into the waste collection container 10. This orientation is opposite to that of the mobile system 108. In the example embodiment disclosed in FIG. 12, the mobile system 109 can optionally comprise a horizontal compactor or ram to eject the compacted waste material from the waste collection container 10 or, in another alternative option, the transport truck 40 may be configured in the style of a dump truck, in which case the waste collection container 10 may be tilted to dump the compacted waste material out of the waste collection container 10 using the force of gravity.

The roller compactor 200 of the mobile system 108, 109 operates by concentrating multiple tons of downward force onto a relatively small area of the waste material and then rolling back and forth quickly across all of the waste material in the waste collection container 10. The roller head of the roller head assembly 230 comprises sharp steel teeth to further break up the waste material and aid compaction thereof. The roller head of the roller head assembly 230 effectively crushes and shreds the waste material, in addition to compacting the waste material vertically. A conventionally used horizontal compactor, by comparison, employs a large surface area equal to the height and width of the waste collection container 10 and, as such, spreads its force over a larger area of the waste material to be compacted together. Additionally, bulky waste materials such as long timbers and steel pipes are known to jam the horizontal compactor. In the example embodiment disclosed herein, the mobile systems 108, 109 can comprise a horizontal compactor (e.g., 300, FIG. 1) to unload the waste material from the waste collection container 10.

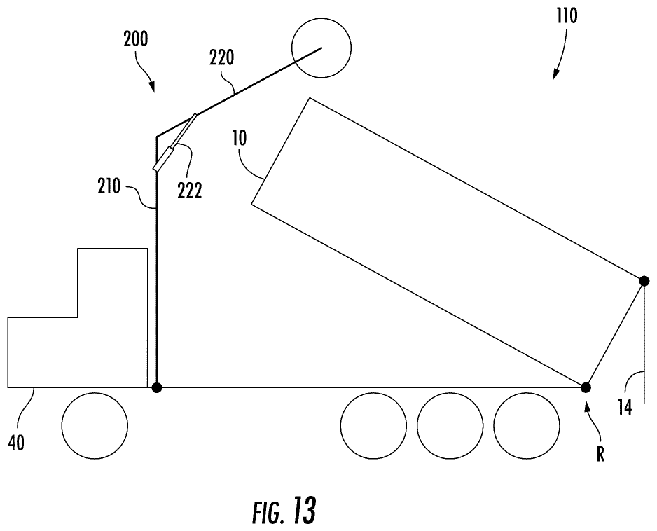

FIG. 13 shows another example embodiment of a mobile system, generally designated 110, in which a waste collection container 10 is pivotably attached to a vehicle, such as transport truck 40. The waste collection container 10 shown in FIG. 13 is substantially similar to the waste collection container shown in FIG. 3. Thus, the mobile system 110 comprises a transport truck 40, a waste collection container 10, and a roller compactor, generally designated 200. The mobile system 110 does not, unlike in mobile system 100, include a horizontal compactor (300, FIG. 1), since the waste material in the waste collection container 10 of FIG. 2 can be unloaded using the force of gravity, such as by rotating the waste collection container 10 from a horizontal position into the inclined position shown in FIG. 2. In the mobile system 110, the waste collection container 10 comprises a door 14 that is pivotably attached at a rear end, or surface, of the waste collection container 10, preferably at a top edge of the waste collection container 10. In this example, the roller compactor 200 is attached to the transport truck 40, between the passenger cabin of the transport truck 40 and the waste collection container 10. In some embodiments, the roller compactor 200 is attached (e.g., directly) to the frame of the transport truck.

The transport truck 40 is configured as a dump truck, in which the waste collection container 10 is attached to the transport truck 40 in a manner that allows the waste collection container 10 to pivot about an axis of rotation R. In the mobile system 110, the waste collection container 10 can be permanently or removably attached to the transport truck 40 during transport of the waste material within the waste collection container 10 to and/or from a waste disposal and/or collection site. Since the mobile system 110 does not have a horizontal compactor, the mobile system 110 relies on gravity-driven unloading of the waste material from the waste collection container 10 upon the waste collection container 10 being pivoted about the axis of rotation R into an inclined position (e.g., in the clockwise direction in the view shown in FIG. 13). While the transport truck 40 is disclosed in this example embodiment as being configured as a dump truck, in some other embodiments, the transport truck 40 may be configured as flat-bed trucks (e.g., trucks that cannot pivot the waste collection container); in such embodiments, a waste collection container 10 having a horizontal compactor (e.g., 300, see FIG. 3), or a similar device or system (e.g., a walking floor) is advantageously utilized for unloading the waste material from the waste collection container 10. Thus, in some embodiments, the waste collection container 10 of the mobile system 110 may have, for example, a horizontal compactor and/or a walking floor for unloading the waste material from the waste collection container 10 thereof. In some embodiments, the roller compactor 200 can be used to expel the waste material from the waste collection container 10 by rotating the roller head of the roller head assembly within the waste collection container 10 against the waste material contained therein, the direction of rotation being in the direction that drives the waste material being contacted by the roller head towards the exit (e.g., door 14) of the waste collection container 10.

Pivoting of the door 14 relative to the waste collection container 10 can be actively or passively driven. In an actively driven embodiment, the pivoting movement of the door 14 is controlled by, for example and without limitation, an actuator, arm, linkage, etc. that moves the door 14 relative to the waste collection container 10. In a passively driven embodiment, the door 14 pivots freely relative to the waste collection container 10 and generally pivots into a position such that the door 14 is coaxial with the gravity vector. A hook, latch, release, etc. may be provided in either embodiment for securing the door 14 during, for example, transport of the waste collection container 10 to prevent unwanted opening of the door 14. The provision of an actively driven door 14 is particularly advantageously used in embodiments in which waste collection container 10 is intended for use on a truck that is not a dump truck. The reason for this is because a horizontal compactor or other device would have to exert a force of sufficient magnitude to also cause the door 14 to pivot into the open position, allowing for the waste material to be expelled from the waste collection container 10.

In some embodiments of the mobile system 110, the bottom surface or floor (e.g., the surface on which the waste material is supported) of the waste collection container 10 is a solid, or substantially solid, structure (e.g., a plate, sheet, etc.). In some embodiments of the mobile system 110, the bottom surface or floor of the waste collection container 10 is a so-called “walking floor” comprising a conveyor-like structure that is used to empty the waste material from the waste collection container 10.

In the example mobile system 110, the roller compactor 200 comprises a boom arm 210, a stick arm 220, and a roller head assembly 230. The boom arm 210 is attached to the waste collection container 10 at a position that allows for the boom arm 210 to pivot in a vertically-extending plane and swivel in a horizontally-extending plane. The pivoting movement of the boom arm 210 is controlled by an actuator. The stick arm 220 is pivotably attached to the boom arm 210 at a distal end of the boom arm 210, opposite the proximal end of the boom arm 210 where the boom arm 210 is attached to the waste collection container 10. The roller compactor 200 comprises a second actuator 222 extending between the boom arm 210 and the stick arm 220 for controlling, by an extension or retraction of the second actuator, a pivoting movement of the stick arm 220 about the distal end of the boom arm 210. The roller head assembly 230 is attached, at a distal end of the stick arm 220, to the stick arm 220. The roller head assembly 230 has a rigid frame, by which the roller head is attached to the stick arm 220. The rigid frame of the roller head assembly 230 is mobile relative to the stick arm 220. For example, the rigid frame may pivot (e.g., rotate in the plane shown in FIG. 13) about the distal end of the stick arm 220, swivel (e.g., rotate in the plane defined by the longitudinal axis of the stick arm 220 and the direction perpendicular to the plane shown in FIG. 13) about the distal end of the stick arm 220, and/or rotate with respect to the longitudinal axis of the stick arm 220. In some embodiments, the roller compactor 200 can have a pivotable, swivelable, and/or rotatable wrist structure, by which the roller head assembly 230 can be attached to the stick arm 220. In some embodiments, the boom arm 210 and/or the stick arm 220 are telescoping arms, with an adjustable length.

The roller compactor 200 is not in any way limited to having only a boom arm 210 and a stick arm 220. Instead, the roller compactor 200 can have any suitable construction, quantity, and type of arms, arm segments, sections, and the like. A nonlimiting example of such arms or arm segments includes one or more telescoping arms or telescoping arm segments. These arms, arm segments, and sections can move in relation to each other in any suitable manner based on the design of the roller compactor 200.

The roller head assembly 230 comprises, in some embodiments, a multi-ton roller head that is rotatably attached to the rigid frame. The roller head has agitators (e.g., spiked teeth) attached to the outer circumferential surface of the roller head. These agitators are shaped and attached to the outer circumferential wall of the roller head to compact and shred virtually any type of bulky waste material into smaller pieces that are more readily compressible with smaller total void area (e.g., having a greater density) within the waste collection container 10. The roller head of the roller head assembly 230 can be either self-powered or unpowered.

In a self-powered embodiment, the roller head assembly 230 can be operably attached to a power source (e.g., hydraulic, pneumatic, or electric) of the waste collection container 10. The power source can be used to move not only the roller head of the roller head assembly 230, but also to move the boom arm 210 relative to the waste collection container 10, to move the stick arm 220 relative to the boom arm 210, and to move the rigid frame of the roller head assembly 230 relative to the stick arm 220. In some self-powered embodiments, the roller head assembly 230 includes an energy storage unit, such as a battery, a motor, and/or a controller configured to receive wireless data transmissions for controlling operation of the roller head.

In the unpowered embodiment, the roller head is not rotatably driven relative to the rigid frame of the roller head assembly 230. Instead, the weight of the roller head is used to exert a compacting force on the waste material, the compacting force acting, for example, in a generally downward direction and the roller head assembly 230 is moved forward-reverse, left-right, and/or up-down by the boom arm 210 and the stick arm 220 of the roller compactor 200, such that the roller head spins as a result of the frictional contact of the roller head 230 with the waste material while the roller head assembly 230 is being moved within the waste collection container 10 by the boom arm 210 and stick arm 220.

In some embodiments, the roller compactor 200 is configured such that the roller head assembly 230 can be positioned external to the waste collection container 10 during loading of the waste material into the waste collection container 10 and during removal of the waste material from the waste collection container 10. The roller head assembly 230 is shown external from the waste collection container 10 in FIG. 13. Optionally, the waste collection container 10 can be provided with a storage structure configured to hold the roller head assembly 230 in a designated location when not in use, so that the roller head assembly 230 does not interfere with the loading/unloading of the waste material into/from the waste collection container 10. In some such embodiments, the storage structure comprises an electrical charger configured to transfer electrical power to the energy storage unit of the roller head assembly 230 (e.g., only while the roller head assembly 230 is positioned in, such as in via direct contact with, electrical contacts provided within the storage structure).

In the example embodiment of the mobile system 110 disclosed herein, the waste collection container 10 is configured as an open-top container, but is not necessarily limited to such configurations; as such, the waste collection container 10 can be any suitable type of container. In some embodiments, the waste collection container 10 can be a structure that is not analogous to a conventional container, at least as such term may be used to conventionally describe a dumpster.

In the example embodiment of the mobile system 110, the transport truck 40 is a lift-back truck, by which the waste collection container 10 is configured to be pivoted about an axis of rotation R to facilitate dumping waste material out of the waste collection container 10. The waste collection container 10 is advantageously only temporarily attached to the transport truck 40 (e.g., in a manner so as to be readily and repeatedly moved onto and off of the transport truck 40) in the mobile system 110.

The largest waste containers used with conventional front-load garbage trucks are 8-10 cubic yards. The presently disclosed mobile systems 100, 101, 102, 104, 105, 106, 107, 108, 109 are advantageously configured to operate using a waste container 10′ with an internal volume of about 15 cubic yards, as bulky waste material requires being deposited in larger waste containers 10′ than are able to be used with conventional garbage trucks. The 15-yard size of the waste containers 10′ is also strategic, as it is half the size of standard 30 yard open top dumpsters, making it easy for customers to understand that two smaller waste containers are being substituted for a single conventional waste container.

In all of the mobile systems disclosed herein that have a roller compactor 200, in the self-powered embodiment thereof, the rotation of the roller head of the roller head assembly 230 can be used to propel the roller head assembly 230 back and forth within the waste collection container 10. Additionally, as described elsewhere herein one or more lift actuators (e.g., hydraulic cylinders) can be used to raise the boom and stick arms. The boom and stick arms 210, 220 are raised into a vertical position at the back of the transport truck 40 during the transfer of the waste material from the waste containers 10′ into the waste collection container 10, so that the roller compactor 200 does not interfere with the waste containers 10′ or, if applicable, with the horizontal compactor 300 as the compacted waste material is being pushed out of the waste collection container 10 (e.g., at a waste aggregation site, otherwise referred to as a “dump” herein). The roller compactor 200 can be supported on the waste collection container 10 by vertical support members (e.g., made of steel or other suitable material) that are welded to the waste collection container 10, internal or external to the waste collection container 10, to provide strength and rigidity for the roller compactor 200. In embodiments in which the roller compactor 200 is hydraulically driven, any of the roller compactors 200 may be connected to the transport truck 40, either to the existing hydraulic system, or to an auxiliary reservoir, pump, PTO, and the like. The roller compactor 200 can be controlled by the operator of the transport truck 40 (e.g., from within the passenger cabin thereof), in a similar manner to how the lifting forks (e.g., 50, 610, 750) are controlled when lifting a waste container 10′ to dump the waste material into the waste collection container 10.

In some embodiments of the mobile systems disclosed herein as having a roller compactor 200, the roller compactor 200 can be provided with flat surfaces, or plates, that are attached to the respective boom and/or stick arms 210, 220 so as to act as a roof, or closure or covering, on the waste collecting container 10 when the boom and stick arms 210, 220 are in a horizontal, extended, position. Such a configuration would allow for the mobile systems disclosed herein as having such a roller compactor 200 to be used for not only collecting and compacting bulky waste materials but also for compacting and hauling conventional (e.g., residential) garbage as well. Additionally, the roof formed by the flat surfaces attached to the boom and stick arms 210, 220 can advantageously prevent the waste product from being blown out of the waste collecting container 10 while the transport truck 40 is in motion. Additionally, a covering for such a waste collection container 10 is generally mandated by law, and this built-in cover would eliminate the need for a tarp system, which most open-top waste trucks employ.

In some embodiments, the components of the lifters 600, 700 of the mobile systems 108, 109 can be synchronized to move with the roller compactor 200, such that the roller compactor 200 is moved out of the way during a dumping procedure and, furthermore, to automatically operate the roller compactor 200 after the waste material has been transferred into the waste collection container 10 and after the waste container 10′ has been moved to a position that will not be contacted by the roller compactor 200 during a compaction procedure.

In some embodiments of the mobile systems 108, 109, the self-powered roller is a standalone roller compactor 200 that is not connected to either of the transport truck 40 or the waste collection container 10, at least when in use to compact the waste material, and can be manipulated by a waste loader (e.g., a grapple) within the waste collection container. In an example embodiment of a self-powered standalone roller, the roller can include an energy storage unit, such as a battery, a motor, and/or a controller configured to receive wireless data transmissions for controlling operation of the roller. A benefit associated with such standalone rollers is that the roller can be positioned external to the waste collection container 10 during loading and/or removal of the waste material into or from the waste collection container 10. In standalone configurations, the roller compactor 200 omits the boom and stick arms 210, 220 and the roller head assembly 230 comprises a frame with a handle by which a waste loader is configured to grasp and manipulate the roller head assembly 230. Optionally, the waste collection container 10 and/or the transport truck 40 can be provided with a storage structure configured to hold such a roller head assembly 230 in a designated location when not in use, so that the roller head assembly 230 does not interfere with the loading or unloading of the waste material into/from the waste collection container 10. In some embodiments, the storage structure comprises an electrical charger configured to transfer electrical power to the energy storage unit of the standalone roller head assembly 230 (e.g., only while the roller head assembly 230 is positioned in, such as via direct contact with, the storage structure).

The mobile systems 106, 107, 108, 109 of FIGS. 6-12 are configured for use with a waste container 10′ that has a volume of about 15 cubic yards, with a length of approximately 12 feet, for example. Such waste containers 10′ are smaller than conventional roll-off style dumpsters and are not typically utilized in the marketplace because the transport truck 40 must transport the dumpster, and therefore twice as many trips would be required to haul two (2) of the smaller waste containers instead of a single conventionally-sized 30 cubic yard dumpster. By using such smaller waste containers 10′, the mobile systems 106, 107, 108, 109 disclosed herein are able to lift such smaller waste containers 10′ and dump the contents thereof into the waste collection container 10, however, even these small waste containers 10′ are still large enough to accommodate bulky waste material therein. The waste compactors 500 and roller compactors 200 disclosed herein with respect to the mobile systems 106, 107, 108, 109 are configured to compact the waste material within the waste collection container 10 by about 30% to about 70% by volume, resulting in the ability of the waste collection container 10 to have therein between about 2× to about 4× more waste material per trip the transport truck 40 makes to the waste aggregation site than currently known systems. In other words, compared to hauling a single 30 cubic yard dumpster, the mobile systems 106, 107, 108, 109 disclosed herein can haul, after compaction of the waste material, the equivalent of about 60-120 cubic yards of uncompacted waste material in the waste collection container during a single trip of the transport truck 40 to the waste aggregation site.

A further advantage provided by using the presently disclosed mobile systems 100, 101, 102, 104, 105, 106, 107, 108, 109 and methods is that the environmental impact per ton of waste material that is removed and transported is reduced. The reason for this is that all waste material that is transported by the presently disclosed mobile systems 100, 101, 102, 104, 105, 106, 107, 108, 109 is compacted, such that no portion of the waste material within the waste collection container 10 thereof is transported in an uncompacted state. As noted elsewhere herein, the empty volume of conventional containers decreases after each subsequent compaction event. By way of example, assume that a conventional dumpster is filled with 100% uncompacted waste material, compacted to 50% by volume, the empty portion is filled again with uncompacted waste material, and is compacted again. In this example, the roller compactor 200 is only compacting about half as much waste material, by volume, during each subsequent compaction event, making subsequent compaction events decreasingly cost-effective and rendering a portion of the waste material in each dumpster uncompacted when retrieved by conventionally known waste removal and transport systems. Thus, the presently disclosed mobile systems 100, 101, 102, 104, 105, 106, 107, 108, 109 and methods are more environmentally sustainable and the miles-traveled-per-ton of waste material is decreased significantly (e.g., by about 50% or more), which reduces carbon emissions and also road wear and tear.

In all of the example embodiments disclosed herein as comprising a roller compactor 200, the rotating movement of the roller head of the roller head assembly 230 also aids in shredding, tearing, splintering, grinding, etc. the waste material. In some embodiments, the movement of the boom arm 210 and/or of the stick arm 220 can be controlled independently of the rotation of the roller head, such that a position of the roller head assembly 230 within the waste collection container 210 can be substantially maintained while the roller head is rotating and/or for moving the roller head within the waste collection container 10 independent of the speed and direction of the rotation of the roller head.

In any of the example embodiments disclosed herein as comprising a horizontal compactor 300, the horizontal compactor 300 can be configured as a ram connected to a plate-like structure for pressing against a wall defined by the waste material within the waste collection container 10.

In any of the example embodiments disclosed herein, the waste collection container 10 may be integral with (e.g., substantially permanently attached to, meaning not intended for ready removal and installation) the transport truck 40, such as may be the case for a front-load or rear-load garbage truck.

The example mobile systems 100, 101, 102, 104, 105, 106, 107, 108, 109 disclosed herein can also improve customer service, particularly for customers having multiple waste containers 10′ at the same location, because the shortened cycle time of servicing multiple waste containers 10′ during a single visit provides less disruption than the requisite multiple visits to the site to remove the same amount of waste material that is required using known prior art systems. Additionally, using the example mobile systems 100, 101, 102, 104, 105, 106, 107, 108, 109 presently disclosed herein, a single transport truck 40 may be used to combine waste material from multiple waste containers 10′ in the same load (i.e., similarly to conventional garbage trucks). Known roll-off dumpster systems can only carry one dumpster at a time. Using the example mobile systems 100, 101, 102, 104, 105, 106, 107, 108, 109 disclosed herein, waste material from multiple waste containers 10′ at multiple job sites can be combined, reducing the number of miles traveled per unit (e.g., ton) of waste material transported to the waste aggregation site, or dump. Additionally, using the example mobile systems 100, 101, 102, 104, 105, 106, 107, 108, 109 disclosed herein, the transport truck 40 is able to continue on to a new waste generating site after emptying a load of compacted waste material at the waste aggregation site, thereby enabling trucks or vehicles that are less expensive to operate to initially deliver the smaller waste containers 10′ and to then collect the waste containers 10′ when no longer needed at the waste generating site.

The example mobile systems 100, 101, 102, 104, 105, 106, 107, 108, 109 disclosed herein are thus able to employ a one-size-fits-all model for different customers by providing the same waste containers 10′ to all customers. By using only waste container 10′ of only a single size, the waste removal needs of all customers can be accommodated because multiples of the smaller waste containers 10′ can be deployed per waste generating site to meet each customer's on-site volume requirements and, further, the contents of multiple smaller waste containers can be transferred into the waste collection container 10. Thus, the types of businesses that can be served is increased by using the waste containers 10′ and the example mobile systems 100, 101, 102, 104, 105, 106, 107, 108, 109 disclosed herein. Using multiple smaller waste containers 10′ means that waste generating sites will not be overstocked or understocked with waste containers 10′ (or provided with waste containers that are incompatible), which increases capital efficiency. Further, using the example mobile systems 100, 101, 102, 104, 105, 106, 107, 108, 109 disclosed herein eliminates the cost associated with the need for tracking the inventory and location of waste containers 10′ of different sizes, as well as the costs associated with the logistical costs of moving waste containers 10′ of a specific size to and/or between customer sites; instead, only one waste container 10′ size can be delivered to all customers.

In some embodiments, the example mobile systems 100, 101, 102, 104, 105, 106, 107, 108, 109 disclosed herein are, partially or entirely, electrically powered. Thus, for example and without limitation, any or all of the roller compactor 200, the horizontal compactor 300, the waste compactor 500, the lifter 600, and/or the lifter 700 can be electrically powered or driven.

In some embodiments of the example mobile systems 101, 104, 105, 108, 109, the roller compactor 200 is attached (e.g., directly) to the transport truck 40, for example, rigidly to the frame of the transport truck 40.

The description herein describes embodiments of the presently disclosed subject matter, and in some cases notes variations and permutations of such embodiments. This description is merely exemplary of the numerous and varied embodiments. The description or mentioning of one or more representative features of a given embodiment is likewise exemplary. Such an embodiment can typically exist with or without the feature(s) mentioned; likewise, all of the features disclosed in each of the example embodiments can be applied to any of the other example embodiments disclosed herein without limitation and without regard to whether the combination of such features is expressly described herein, unless a preclusion against the combination of such features is expressly noted herein.

It will be understood that various details of the presently disclosed subject matter may be changed without departing from the scope of the presently disclosed subject matter. Furthermore, the foregoing description of the example embodiments disclosed herein is only provided for the purpose of illustration only and is not to be used to limit in any way the scope of the subject matter disclosed herein.

1. A mobile system for collecting, compacting, and transporting a waste material from a waste generating site, the mobile system comprising:
a transport truck;
a waste collection container configured for attachment to the transport truck and to hold the waste material;
a lifter comprising lift forks that are configured to extend in front of the transport truck and load the waste material into the waste collection container; and
a roller compactor configured to compact the waste material in the waste collection container to increase a density of the waste material within the waste collection container relative to an initial, uncompacted density of the waste material in the waste collection container.

2. The mobile system of claim 1, wherein the roller compactor comprises a roller head, which is rotatable about an axis of rotation.

3. The mobile system of claim 2, wherein the roller compactor comprises:
a boom arm, which is pivotably and/or rotatably connected to the waste collection container; and
a stick arm, which is pivotably connected to the boom arm.

4. The mobile system of claim 3, wherein the roller head is configured to be positioned external to the waste collection container while the waste material is transferred into the waste collection container from an external waste container.

5. The mobile system of claim 3, wherein:
the roller head is configured to generate a downwardly-oriented compaction force on the waste material within the waste collection container; and
wherein the roller head comprises rigidly attached agitators that engage with and break apart the waste material to increase the density of the waste material within the waste collection container.

6. The mobile system of claim 3, wherein the roller head is powered for rotation to provide propulsion for moving the roller head throughout the waste collection container.

7. The mobile system of claim 3, wherein the roller head is not powered for rotation, such that the boom arm and the stick arm connected to the roller head are configured to move the roller head throughout the waste collection container, the roller head rotating only due to friction with the waste material being compacted.

8. The mobile system of claim 3, wherein, for moving the roller head throughout the waste collection container:
the boom arm is configured to extend, retract, pivot up, pivot down, swivel left, and/or swivel right; and
the stick arm is configured to extend, retract, pivot up, and/or pivot down.

9. The mobile system of claim 3, wherein the roller compactor is mounted to the waste collection container in such a way that the roller head is movable throughout the waste collection container, including in forward, rear, up, and down directions.

10. The mobile system of claim 3, comprising a door or gate in a rear wall of the waste collection container.

11. The mobile system of claim 10, wherein:
the roller compactor is mounted to a top edge of the waste collection container, above the door or gate; or
the roller compactor is mounted to the top edge of the waste collection container on a front side thereof, opposite the door or gate.

12. The mobile system of claim 1, wherein the lifter is attached to the transport truck.

13. The mobile system of claim 12, wherein:
the transport truck is configured as a dump truck, the waste collection container being pivotably attached to the transport truck; or
the transport truck is configured as a roll-off truck, the waste collection container being configured to slide or roll on and off of the transport truck.

14. The mobile system of claim 13, wherein the waste compactor is mounted to the transport truck in such a way that the roller head is movable throughout the waste collection container, including in forward, rear, up, and down directions.

15. The mobile system of claim 12, wherein:
the lifter comprises a rigid frame that extends from a pivot point and is attached to the transport truck; and
the lift forks are attached to the rigid frame for lifting an external waste container about the pivot point to transfer any waste material within the external waste container into the waste collection container.

16. The mobile system of claim 1, wherein the roller compactor comprises:
an energy storage unit, such as a battery;
a motor; and/or
a controller configured to receive data transmissions for controlling operation of the roller compactor, optionally, the data transmissions being transmitted in a wireless and/or wired manner.

17. The mobile system of claim 1, wherein the roller compactor is configured to compact and shred the waste material within the waste collection container.

18. A method for collecting, compacting, and transporting a waste material from a waste container at a waste generating site, the method comprising:
providing a transport truck;
attaching a waste collection container to the transport truck;
receiving, using a lifter, the waste material from the waste container within the waste collection container; and
compacting, via a roller compactor, the waste material in the waste collection container to increase a density of the waste material within the waste collection container relative to an initial, uncompacted density of the waste material in the waste collection container;
wherein the lifter comprises lift forks that extend in front of the transport truck for engaging with an external waste container.

19. The method of claim 18, wherein the roller compactor comprises:
a roller head, which is rotatable about an axis of rotation;
a boom arm, which is pivotable and/or rotatably connected to the waste collection container; and
a stick arm, which is pivotably and/or rotatable connected to the boom arm.

20. A mobile system for collecting, compacting, and transporting a waste material from a waste generating site, the mobile system comprising:
a transport truck in a form of a dump truck or a roll-off truck;
a waste collection container configured for attachment to the transport truck and to hold the waste material, the waste collection container comprising a door or gate in a rear wall of the waste collection container;
a lifter that is attached to the transport truck and comprises:
a rigid frame that extends from a pivot point and is attached to the waste collection container and/or the transport truck;
lift forks that are attached to the rigid frame and extend in front of the transport truck for lifting an external waste container about the pivot point to transfer any waste material from the external waste container into the waste collection container; and
a roller compactor configured to compact and shred the waste material within the waste collection container, the roller compactor comprising:
a roller head, which comprises rigidly attached agitators, is configured to generate a downwardly-oriented compaction force on the waste material within the waste collection container, and is rotatable about an axis of rotation;
a boom arm, which is pivotable and/or rotatably connected to the waste collection container;
a stick arm, which is pivotably and/or rotatable connected to the boom arm;
an energy storage unit;
a motor; and
a controller configured to receive data transmissions for controlling operation of the roller compactor, the data transmissions being transmitted in a wireless and/or wired manner;
wherein the roller compactor is mounted to the waste collection container in such a way that the roller head is movable throughout the waste collection container, including in forward, rear, up, and down directions; and
wherein the roller compactor is mounted to a top edge of the waste collection container, either at the rear wall of the waste collection container or a front wall of the waste collection container;
wherein the roller compactor is configured to compact the waste material in the waste collection container to increase a density of the waste material within the waste collection container relative to an initial, uncompacted density of the waste material in the waste collection container;
wherein the roller head is configured to be positioned external to the waste collection container while the waste material is transferred into the waste collection container from the external waste container;
wherein the agitators are configured to engage with and break apart the waste material to increase the density of the waste material within the waste collection container;
wherein the roller head is:
powered for rotation to provide propulsion for moving the roller head throughout the waste collection container; or
not powered for rotation, such that the boom arm and the stick arm connected to the roller head are configured to move the roller head throughout the waste collection container, the roller head rotating only due to friction with the waste material being compacted; and
wherein, for moving the roller head throughout the waste collection container:
the boom arm is configured to extend, retract, pivot up, pivot down, swivel left, and/or swivel right; and
the stick arm is configured to extend, retract, pivot up, and/or pivot down.
